(19) United States
(12) Patent Application Publication
(10) Pub. No.: US 2015/0294577 A1
(43) Pub. Date: Oct. 15, 2015

(54) NEUROPERFORMANCE

(71) Applicant: ASPEN PERFORMANCE TECHNOLOGIES, Tel Aviv (IL)

(72) Inventors: Jose Roberto KULLOK, Efrat (IL); Saul KULLOK, Efrat (IL)

(21) Appl. No.: 14/468,985

(22) Filed: Aug. 26, 2014

Related U.S. Application Data
(63) Continuation-in-part of application No. 14/251,116, filed on Apr. 11, 2014.
Application No. 14/251,116 is a continuation-in-part of application No. 14/251,163, filed on Apr. 11, 2014.
Application No. 14/251,163 is a continuation-in-part of application No. 14/251,007, filed on Apr. 11, 2014.
Application No. 14/251,007 is a continuation-in-part of application No. 14/251,034, filed on Apr. 11, 2014.
Application No. 14/251,034 is a continuation-in-part of application No. 14/251,041, filed on Apr. 11, 2014.

(51) Int. Cl. G09B 5/02; G09B 19/00

(52) U.S. Cl. CPC G09B 5/02; G09B 19/00

(57) ABSTRACT

Methods of promoting searching, pattern recognition and sensory motor selection in a subject including the steps of: selecting a first number of open-bigram terms as target terms and a second number of open-bigram terms as distractor terms, both from any class and all having the same spatial and time perceptual related attributes, arranging the open-bigrams terms in a matrix format in a number of arrays, selecting one or more sectors in the matrix where the target terms replace an equal number of distractor terms; providing the subject with the arranged matrix along with a ruler displaying a predefined alphabetic letters sequence; prompting the subject to search, recognize, and select all of the target terms within a first predefined period of time; and displaying correctly identified target terms with a changed spatial or time perceptual related attribute.

This is a Continuation-In-Part of U.S. patent application Ser. No. 14/251,116, U.S. patent application Ser. No. 14/251,163, U.S. patent application Ser. No. 14/251,007, U.S. patent application Ser. No. 14/251,034, and U.S. patent application Ser. No. 14/251,041, all filed on Apr. 11, 2014, the disclosure of each which is hereby incorporated by reference.

### FIELD

The present disclosure relates to a system, method, software, and tools employing a novel disruptive non-pharmacological technology that prompts correlation of a subject's sensory-motor-perceptual-cognitive activities with novel constrained sequential statistical and combinatorial properties of alphanumerical series of symbols (e.g., in alphabetical series, letter sequences and series of numbers). These statistical and combinatorial properties determine alphanumeric sequential relationships by establishing novel interrelations, correlations and cross-correlations among the sequence terms. The new interrelations, correlations and cross-correlations among the sequence terms prompted by this novel non-pharmacological technology sustain and promote neural plasticity in general and neural-linguistic plasticity in particular. This technology is carried out through new strategies implemented by exercises particularly designed to amplify these novel sequential alphanumeric interrelations, correlations and cross-correlations. More importantly, this non-pharmacological technology entwines and grounds sensory-motor-perceptual-cognitive activity to statistical and combinatorial information constraining serial orders of alphanumeric symbols sequences. As a result, the problem solving of the disclosed body of alphanumeric series exercises is hardly cognitively taxing and is mainly conducted via fluid intelligence abilities (e.g., inductive-deductive reasoning, novel problem solving, and spatial orienting).

A primary goal of the non-pharmacological technology disclosed herein is maintaining stable cognitive abilities, delaying, and/or preventing cognitive decline in a subject experiencing normal aging. Likewise, this goal includes restraining working and episodic memory and cognitive impairments in a subject experiencing mild cognitive decline associated, e.g., with mild cognitive impairment (MCI) or pre-dementia and delaying the progression of severe working, episodic and prospective memory and cognitive decay at the early phase of neural degeneration in a subject diagnosed with a neurodegenerative condition (e.g., Dementia, Alzheimer's, Parkinson's). The non-pharmacological technology is beneficial as a training cognitive intervention designated to improve the instrumental performance of an elderly person in daily demanding functioning tasks by enabling some transfer from fluid cognitive trained abilities to everyday functioning. Further, this non-pharmacological technology is also beneficial as a brain fitness training/cognitive learning enhancer tool for the normal aging population, a subpopulation of Alzheimer's patients (e.g., stage 1 and beyond), and in subjects who do not yet experience cognitive decline.

### BACKGROUND

Brain/neural plasticity refers to the brain's ability to change in response to experience, learning and thought. As the brain receives specific sensorial input, it physically changes its structure (e.g., learning). These structural changes take place through new emergent interconnectivity growth connections among neurons, forming more complex neural networks. These recently formed neural networks become selectively sensitive to new behaviors. However, if the capacity for the formation of new neural connections within the brain is limited for any reason, demands for new implicit and explicit learning, (e.g., sequential learning, associative learning) supported particularly on cognitive executive functions such as fluid intelligence-inductive reasoning, attention, memory and speed of information processing (e.g., visual-auditory perceptual discrimination of alphanumeric patterns or pattern irregularities) cannot be satisfactorily fulfilled. This insufficient “neural connectivity” causes the existing neural pathways to be overworked and over stressed, often resulting in gridlock, a momentary information processing slow down and/or suspension, cognitive overflow or in the inability to dispose of irrelevant information. Accordingly, new learning becomes cumbersome and delayed, manipulation of relevant information in working memory compromised, concentration overtaxed and attention span limited.

Worldwide, millions of people, irrespective of gender or age, experience daily awareness of the frustrating inability of their own neural networks to interconnect, self-reorganize, retrieve and/or acquire new knowledge and skills through learning. In normal aging population, these maladaptive learning behaviors manifest themselves in a wide spectrum of cognitive functional and Central Nervous System (CNS) structural maladies, such as: (a) working and short-term memory shortcomings (including, e.g., executive functions), over increasing slowness in processing relevant information, limited memory storage capacity (items chunking difficulty), retrieval delays from long term memory and lack of attentional span and motor inhibitory control (e.g., impulsivity); (b) noticeable progressive worsening of working, episodic and prospective memory, visual-spatial and inductive reasoning (but also deductive reasoning) and (c) poor sequential organization, prioritization and understanding of meta-cognitive information and goals in mild cognitively impaired (MCI) population (who don't yet comply with dementia criteria); and (d) signs of neural degeneration in pre-dementia MCI population transitioning to dementia (e.g., these individuals comply with the diagnosis criteria for Alzheimer's and other types of Dementia.).

The market for memory and cognitive ability improvements, focusing squarely on aging baby boomers, amounts to approximately 76 million people in the US, tens of millions of whom either are or will be turning 60 in the next decade. According to research conducted by the Natural Marketing Institute (NMI), U.S., memory capacity decline and cognitive ability loss is the biggest fear of the aging baby boomer population. The NMI research conducted on the US general population showed that 44 percent of the US adult population reported memory capacity decline and cognitive ability loss as their biggest fear. More than half of the females (52 percent) reported memory capacity and cognitive ability loss as their biggest fear about aging, in comparison to 36 percent of the males.

Neurodegenerative diseases such as dementia, and specifically Alzheimer's disease, may be among the most costly diseases for society in Europe and the United States. These costs will probably increase as aging becomes an important social problem. Numbers vary between studies, but dementia worldwide costs have been estimated around $160 billion, while costs of Alzheimer in the United States alone may be $100 billion each year.

Currently available methodologies for addressing cognitive decline predominantly employ pharmacological interventions directed primarily to pathological changes in the brain (e.g., accumulation of amyloid protein deposits). However, these pharmacological interventions are not completely effective. Moreover, importantly, the vast majority of pharmacological agents do not specifically address cognitive aspects of the condition. Further, several pharmacological agents are associated with undesirable side effects, with many agents that in fact worsen cognitive ability rather than improve it. Additionally, there are some therapeutic strategies which cater to improvement of motor functions in subjects with neurodegenerative conditions, but such strategies too do not specifically address the cognitive decline aspect of the condition.

Thus, in view of the paucity in the field vis-à-vis effective preventative (prophylactic) and/or therapeutic approaches, particularly those that specifically and effectively address cognitive aspects of conditions associated with cognitive decline, there is a critical need in the art for non-pharmacological (alternative) approaches.

With respect to alternative approaches, notably, commercial activity in the brain health digital space views the brain as a “muscle”. Accordingly, commercial vendors in this space offer diverse platforms of online brain fitness games aimed to exercise the brain as if it were a “muscle,” and expect improvement in performance of a specific cognitive skill/domain in direct proportion to the invested practice time. However, vis-à-vis such approaches, it is noteworthy that language is treated as merely yet another cognitive skill component in their fitness program. Moreover, with these approaches, the question of cognitive skill transferability remains open and highly controversial.

The non-pharmacological technology disclosed herein is implemented through novel neuro-linguistic cognitive strategies, which stimulate sensory-motor-perceptual abilities in correlation with the alphanumeric information encoded in the sequential, combinatorial and statistical properties of the serial orders of its symbols (e.g., in the letters series of a language alphabet and in a series of numbers 1 to 9). As such, this novel non-pharmacological technology is a kind of biological intervention tool which safely and effectively triggers neuronal plasticity in general, across multiple and distant cortical areas in the brain. In particular, it triggers hemispheric related neural-linguistic plasticity, thus preventing or decelerating the chemical break-down initiation of the biological neural machine as it grows old.

The present non-pharmacological technology accomplishes this by principally focusing on the root base component of language, its alphabet, organizing its constituent parts, namely its letters and letter sequences (chunks) in novel ways to create rich and increasingly new complex non-semantic (serial non-word chunks) networking. This technology explicitly reveals the most basic minimal semantic textual structures in a given language (e.g., English) and creates a novel alphanumeric platform by which these minimal semantic textual structures can be exercised within the given language alphabet. The present non-pharmacological technology also accomplishes this by focusing on the natural numbers numerical series, organizing its constituent parts, namely its single number digits and number sets (numerical chunks) in novel serial ways to create rich and increasingly new number serial configurations.

From a developmental standpoint, language acquisition is considered to be a sensitive period in neuronal plasticity that precedes the development of top-down brain executive functions, (e.g., memory) and facilitates “learning”. Based on this key temporal relationship between language acquisition and complex cognitive development, the non-pharmacological technology disclosed herein places ‘native language acquisition’ as a central causal effector of cognitive, affective and psychomotor development. Further, the present non-pharmacological technology derives its effectiveness, in large part, by strengthening, and recreating fluid intelligence abilities such as inductive reasoning performance/processes, which are highly engaged during early stages of cognitive development (which stages coincide with the period of early language acquisition). Furthermore, the present non-pharmacological technology also derives its effectiveness by promoting efficient processing speed of phonological and visual pattern information among alphabetical serial structures (e.g., letters and letter patterns and their statistical and combinatorial properties, including non-word letter patterns), thereby promoting neuronal plasticity in general across several distant brain regions and hemispheric related language neural plasticity in particular.

The advantage of the non-pharmacological cognitive intervention technology disclosed herein is that it is effective, safe, and user-friendly, demands low arousal thus low attentional effort, is non-invasive, has no side effects, is non-addictive, scalable, and addresses large target markets where currently either no solution is available or where the solutions are partial at best.

### BRIEF DESCRIPTION OF DRAWINGS

FIG. 1 is a flow chart setting forth the broad concepts covered by the specific non-limiting exercises put forth in Example 1 disclosed herein.

FIG. 2 shows a non-limiting exemplary open proto-bigrams terms matrix configuration.

FIGS. 3A-3B depict a non-limiting example of the exercises for promoting pattern recognition and sensory motor selection of open proto-bigram terms. FIG. 3A shows an arranged open proto-bigrams terms matrix with two different open proto-bigrams, one being the target term and the other being the distractor term. FIG. 3B shows correctly selected target term “IF.”

FIGS. 4A-4B depict another non-limiting example of the exercises for promoting pattern recognition and sensory motor selection of open proto-bigram terms. FIG. 4A shows an arranged open proto-bigrams terms matrix with a single open proto-bigram term as both the target and distractor terms. However, in this case since only a single open proto-bigram term is utilized, the target and distractor terms are distinguished by font size. FIG. 4B shows correctly selected smaller font size target term “NO.”

FIGS. 5A-5B depict another non-limiting example of the exercises for promoting pattern recognition and sensory motor selection of open proto-bigram terms. FIG. 5A shows an arranged open proto-bigrams terms matrix with two different open proto-bigrams, one being the target term and the other being the distractor term. The two open proto-bigram terms also have different font sizes. FIG. 5B shows correctly selected target term “NO.”

FIGS. 6A-6D depict another non-limiting example of the exercises for promoting pattern recognition and sensory motor selection of open proto-bigram terms. FIG. 6A shows an arranged open proto-bigrams terms matrix with a single open proto-bigram as the target and distractor terms and distinguished by font type. FIG. 6B shows the correctly identified targets. Similarly, FIGS. 6C and 6D depict an arranged open proto-bigrams matrix with a single open proto-bigram as the target and distractor terms that are differentiated by font boldness.

FIGS. 7A-7B depict another set of non-limiting examples of the exercises for promoting pattern recognition and sensory motor selection of open proto-bigram terms. In FIG. 7A, there is an arranged open proto-bigrams terms matrix with two different open proto-bigram target-distractors terms from the same matrix sector. The target terms are distinguished by a different font angular rotation. Similarly, FIG. 7B shows another arranged open proto-bigrams terms matrix with two different open proto-bigram target and distractor terms distinguished by the target term having a different font angular rotation. However, in this case, the open proto-bigram terms are selected from two different matrix sectors.

FIGS. 8A-8D depict another set of non-limiting examples of the exercises for promoting pattern recognition and sensory motor selection of open proto-bigram terms. In FIG. 8A, there is an arranged open proto-bigrams terms matrix with a single open proto-bigram term as both the target and distractor terms. The target terms are distinguished by a different font type. FIG. 8B shows the arranged matrix but with the target terms having “disappeared.” FIG. 8C shows the arranged matrix having only distractor terms, which the subject sees during the “intermittency” period. FIG. 8D shows the correctly selected targets “IN.”

FIGS. 9A-9D depict another set of non-limiting examples of the exercises for promoting pattern recognition and sensory motor selection of open proto-bigram terms. In FIG. 9A, there is an arranged open proto-bigrams terms matrix with a single open proto-bigram term representing both the target and distractor terms, the target terms distinguished by a smaller font size. FIGS. 9B and 9C show the target terms having moved into different cell positions. FIG. 9D shows all of the correctly identified target terms.

FIGS. 10A-10D depict another set of non-limiting examples of the exercises for promoting pattern recognition and sensory motor selection of open proto-bigram terms. In FIG. 10A, there is an arranged open proto-bigrams terms matrix with a single open proto-bigram term representing both the target and distractor terms. The target term is also distinguished by a different font size. FIG. 10B shows the arranged matrix with the all of target and distractor terms having the angular rotation spatial perceptual related attribute changed as well as their position in the matrix. In FIG. 10C, the target terms are shown in another different position within the matrix as well as having a change in font boldness. FIG. 10D shows the correctly selected target terms.

FIGS. 11A-11D depict another set of non-limiting examples of the exercises for promoting pattern recognition and sensory motor selection of open proto-bigram terms. In FIG. 11A, there is an arranged open proto-bigrams terms matrix with two different open proto-bigram terms from the same matrix sector, one representing the target term and the other representing the distractor term. FIG. 11B shows a horizontal array containing a target term having shifted to the right. FIG. 11C shows further transposition of the horizontal array containing the target term to the right. FIG. 11D shows the correctly selected target term in a third shifted position in the array.

### DETAILED DESCRIPTION

### Introduction

It is generally assumed that individual letters and the mechanism responsible for coding the positions of these letters in a string are the key elements for orthographic processing and determining the nature of the orthographic code. To expand the understanding of the mechanisms that interact, inhibit and modulate orthographic processing, there should also be an acknowledgement of the ubiquitous influence of phonology in reading comprehension. There is a growing consensus that reading involves multiple processing routes, namely the lexical and sub-lexical routes. In the lexical route, a string directly accesses lexical representations. When a visual image first arrives at a subject's cortex, it is in the form of a retinotopic encoding. If the visual stimulus is a letter string, an encoding of the constituent letter identities and positions takes place to provide a suitable representation for lexical access. In the sub-lexical route, a string is transformed into a phonological representation, which then contacts lexical representations.

Indeed, there is growing consensus that orthographic processing must connect with phonological processing quite early on during the process of visual word recognition, and that phonological representations constrain orthographic processing (Frost, R. (1998) Toward a strong phonological theory of visual word recognition: True issues and false trails, Psychological Bulletin, 123, 71_{—}99; Van Orden, G. C. (1987) A ROWS is a ROSE: Spelling, sound, and reading, Memory and Cognition, 15(3), 181-1987; and Ziegler, J. C., & Jacobs, A. M. (1995), Phonological information provides early sources of constraint in the processing of letter strings, Journal of Memory and Language, 34, 567-593).

Another major step forward in orthographic processing research concerning visual word recognition has taken into consideration the anatomical constraints of the brain to its function. Hunter and Brysbaert describe this anatomical constraint in terms of interhemispheric transfer cost (Hunter, Z. R., & Brysbaert, M. (2008), Theoretical analysis of interhemispheric transfer costs in visual word recognition, Language and Cognitive Processes, 23, 165-182). The assumption is that information falling to the right and left of fixation, even within the fovea, is sent to area V1 in the contralateral hemisphere. This implies that information to the left of fixation (LVF), which is processed initially by the right hemisphere of the brain, must be redirected to the left hemisphere (collosal transfer) in order for word recognition to proceed intact.

Still, another general constraint to orthographic processing is the fact that written words are perceived as visual objects before attaining the status of linguistic objects. Research has revealed that there seems to be a pre-emption of visual object processing mechanisms during the process of learning to read (McCandliss, B., Cohen, L., & Dehaene, S. (2003), The visual word form area: Expertise for reading in the fusiform gyrus, Trends in Cognitive Sciences, 13, 293-299). For example, the alphabetic array proposed by Grainger and van Heuven is one such mechanism, described as a specialized system developed specifically for the processing of strings of alphanumeric stimuli (but not for symbols) (Grainger, J., & van Heuven, W. (2003), Modeling letter position coding in printed word perception, In P. Bonin (Ed.), The mental lexicon (pp. 1-23), New York: Nova Science).

### Transposed Letter (TL) Priming

The effects of letter order on visual word recognition have a long research history. Early on during word recognition, letter positions are not accurately coded. Evidence of this comes from transposed-letter (TL) priming effects, in which letter strings generated by transposing two adjacent letters (e.g., “jugde” instead of “judge”) produce large priming effects, more than the priming effect with the letters replaced by different letters in the corresponding position (e.g., “junpe” instead of “judge”). Yet, the clearest evidence for TL priming effects was obtained from experiments using non-word anagrams formed by transposing two letters in a real word (e.g., “mohter” instead of “mother”) and comparing performance with matched non-anagram non-words (Andrews, S. (1996), Lexical retrieval and selection processes: Effects of transposed letter confusability, Journal of Memory and Language, 35, 775-800; Bruner, J. S., & O'Dowd, D. (1958), A note on the informativeness of parts of words, Language and Speech, 1, 98-101; Chambers, S. M. (1979), Letter and order information in lexical access, Journal of Verbal Learning and Behavior, 18, 225-241; O'Connor, R. E., & Forster, K. I. (1981), Criterion bias and search sequence bias in word recognition, Memory and Cognition, 9, 78-92; and Perea, M., Rosa, E., & Gomez, C. (2005), The frequency effect for pseudowords in the lexical decision task, Perception and Psychophysics, 67, 301-314). These experiments show that TL non-word anagrams are more often misperceived as a real word or misclassified as a real word in a lexical decision task than the non-anagram controls.

Other experiments that focused on the role of letter order in the perceptual matching task in which subjects had to classify two strings of letters as being either the same or different exhibited a diversity of responses depending on the number of shared letters and the degree to which the shared letters match in ordinal position (Krueger, L. E. (1978), A theory of perceptual matching, Psychological Review, 85, 278-304; Proctor, R. W., & Healy, A. F. (1985), Order-relevant and order-irrelevant decision rules in multiletter matching, Journal of Experimental Psychology: Learning, Memory, and Cognition, 11, 519-537; and Ratcliff, R. (1981), A theory of order relations in perceptual matching, Psychological Review, 88, 552-572). Observed priming effects were ruled by the number of letters shared across prime and target and the degree of positional match. Still, Schoonbaert and Grainger found that the size of TL-priming effects might depend on word length, with larger priming effects for 7-letter words as compared with 5-letter words (Schoonbaert, S., & Grainger, J. (2004), Letter position coding in printed word perception: Effects of repeated and transposed letters, Language and Cognitive Processes, 19, 333-367). More so, Guerrera and Foster found robust TL-priming effects in 8-letter words with rather extreme TL operations involving three transpositions e.g., 13254768-12345678 (Guerrera, C., & Forster, K. I. (2008), Masked form priming with extreme transposition, Language and Cognitive Processes, 23, 117-142). In short, target word length and/or target neighborhood density strongly determines the size of TL-priming effects.

Of equal importance, TL priming effects can also be obtained with the transposition of non-adjacent letters. The robust effects of non-adjacent TL primes were reported by Perea and Lupker with 6-10 letter long Spanish words (Perea, M., & Lupker, S. J. (2004), Can CANISO activate CASINO? Transposed-letter similarity effects with nonadjacent letter positions, Journal of Memory and Language, 51(2), 231-246). Same TL primes effects were reported in English words by Lupker, Perea, and Davis (Lupker, S. J., Perea, M., & Davis, C. J. (2008), Transposed-letter effects: Consonants, vowels, and letter frequency, Language and Cognitive Processes, 23, (1), 93-116). Additionally, Guerrera and Foster have shown that priming effects can be obtained when primes include multiple adjacent transpositions e.g., 12436587-12345678 (Guerrera, C., & Forster, K. I. (2008), Masked form priming with extreme transposition, Language and Cognitive Processes, 23, 117-142).

Past research regarding a possible influence of letter position (inner versus outer letters) in TL priming has shown that non-words formed by transposing two inner letters are harder to respond to in a lexical decision task than non-words formed by transposing the two first or the two last letters (Chambers, S. M. (1979), Letter and order information in lexical access, Journal of Verbal Learning and Behavior, 18, 225-241). Still, Schoonbaert and Grainger provided evidence that TL primes involving an outer letter (the first or the last letter of a word) are less effective than TL primes involving two inner letters (Schoonbaert, S., & Grainger, J. (2004), Letter position coding in printed word perception: Effects of repeated and transposed letters, Language and Cognitive Processes, 19, 333-367). Guerrera and Foster also suggested a special role of a word's outer letters (Guerrera, C., & Forster, K. I. (2008), Masked form priming with extreme transposition, Language and Cognitive Processes, 23, 117-142; and Jordan, T. R., Thomas, S. M., Patching, G. R., & Scott-Brown, K. C. (2003), Assessing the importance of letter pairs in initial, exterior, and interior positions in reading, Journal of Experimental Psychology: Learning, Memory, and Cognition, 29, 883-893).

In all of the above-mentioned studies, the TL priming contained all of the target's letters. When primes do not contain the entire target's letters, TL priming effects diminish substantially and tend to vanish (Humphreys, G. W., Evett, L. J., & Quinlan, P. T. (1990), Orthographic processing in visual word identification, Cognitive Psychology, 22, 517-560; and Peressotti, F., & Grainger, J. (1999), The role of letter identity and letter position in orthographic priming, Perception and Psychophysics, 61, 691-706).

### Relative-Position (RP) Priming

Relative-position (RP) priming involves a change in length across the prime and target such that shared letters can have the same order without being matched in terms of absolute length-dependent positions. RP priming can be achieved by removing some of the target's letters to form the prime stimulus (subset priming) or by adding letters to the target (superset priming). Primes and targets differing in length are obtained so that absolute position information changes while the relative order of letters is preserved. For example, for a 5-letter target e.g., 12345, a 5-letter substitution prime such as 12d45 contains letters that have the same absolute position in the prime and the target, while a 4-letter subset prime such as 1245 contains letters that preserve their relative order in the prime and the target but not their precise length-dependent position. Humphreys et al. reported significant priming for primes sharing four out of five of the target's letters in the same relative position (1245) compared to both a TL prime condition (1435) and an outer-letter only condition ldd5 (Humphreys, G. W., Evett, L. J., & Quinlan, P. T. (1990), Orthographic processing in visual word identification, Cognitive Psychology, 22, 517-560).

Peressotti and Grainger provided further evidence for the effects of RL priming using the Foster and Davis masked priming technique. They reported that, with 6-letter target words, RP primes (1346) produced a significant priming effect compared with unrelated primes (dddd). Meanwhile, violation of the relative position of letters across the prime and the target e.g., 1436, 6341 cancelled priming effects relative to all different letter primes e.g., dddd (Peressotti, F., & Grainger, J. (1999), The role of letter identity and letter position in orthographic priming, Perception and Psychophysics, 61, 691-706). Grainger et al., reported small advantages for beginning-letter primes e.g., 1234/12345 compared with end-letter primes e.g., 4567/6789 (Grainger, J., Granier, J. P., Farioli, F., Van Assche, E., & van Heuven, W. (2006a), Letter position information and printed word perception: The relative position priming constraint, Journal of Experimental Psychology: Human Perception and Performance, 32, 865-884). Likewise, an advantage for completely contiguous primes e.g., 1234/12345-34567/56789 is explained in terms of a phonological overlap in the contiguous condition compared with non-contiguous primes e.g., 1357/13457/1469/14569 (Frankish, C., & Turner, E. (2007), SIHGT and SUNOD: The role of orthography and phonology in the perception of transposed letter anagrams, Journal of Memory and Language, 56, 189-211). Further, Schoonbaert and Grainger utilize 7-letter target words containing a non-adjacent repeated letter such as “balance” and form prime stimuli “balnce” or “balace”. They reported priming effects were not influenced by the presence or absence of a letter repetition in the formed prime stimulus. On the other hand, performance to target stimuli independently of prime condition was adversely affected by the presence of a repeated letter, and this was true for both the word and non-word targets (Schoonbaert, S., & Grainger, J. (2004), Letter position coding in printed word perception: Effects of repeated and transposed letters, Language and Cognitive Processes, 19, 333-367).

Letter Position Serial Encoding: The SERIOL model

The SERIOL model (Sequential Encoding Regulated by Inputs to Oscillations within Letter units) is a theoretical framework that provides a comprehensive account of string processing in the proficient reader. It offers a computational theory of how a retinotopic representation is converted into an abstract representation of letter order. The model mainly focuses on bottom-up processing, but this is not meant to rule out top-down interactions.

The SERIOL model is comprised of five layers: 1) edges, 2) features, 3) letters, 4) open-bigrams, and 5) words. Each layer is comprised of processing units called nodes, which represent groups of neurons. The first two layers are retinotopic, while the latter three layers are abstract. For the retinotopic layers, the activation level denotes the total amount of neural activity across all nodes devoted to representing a letter within a given layer. A letter's activation level increases with the number of neurons representing that letter and their firing rate. For the abstract layers, the activation denotes the activity level of a representational letter unit in a given layer. In essence, the SERIOL model is the only one that specifies an abstract representation of individual letters. Such a letter unit can represent that letter in any retinal location, wherein timing firing binds positional information in the string to letter identity.

The edge layer models early visual cortical areas V1/V2. The edge layer is retinotopically organized and is split along the vertical meridian corresponding to the two cerebral hemispheres. In these early visual cortical areas, the rate of spatial sampling (acuity) is known to sharply decrease with increasing eccentricity. This is modelled by the assumption that activation level decreases as distance from fixation increases. This pattern is termed the ‘acuity gradient’. In short, the activation pattern at the lowest level of the model, the edge layer, corresponds to visual acuity.

The feature layer models V4. The feature layer is also retinotopically organized and split across the hemispheres. Based on learned hemisphere-specific processing, the acuity gradient of the edge layer is converted to a monotonically decreasing activation gradient (called the locational gradient) in the feature layer. The activation level is highest for the first letter and decreases across the string. Hemisphere-specific processing is necessary because the acuity gradient does not match the locational gradient in the first half of a fixated word (i.e., acuity increases from the first letter to the fixated letter and the locational gradient decreases across the string), whereas the acuity gradient and locational gradient match in the second half of the word (i.e., both decreasing). Strong directional lateral inhibition is required in the hemisphere (for left-to-right languages—Right Hemisphere [RH]) contralateral to the first half of the word (for left-to-right languages—Left Visual Field [LVF]), in order to invert the acuity gradient.

At the letter layer, corresponding to the posterior fusiform gyrus, letter units fire serially due to the interaction of the activation gradient with oscillatory letter nodes (see above feature layer). That is, the letter unit encoding the first letter fires, then the unit encoding the second letter fires, etc. This mechanism is based on the general proposal that item order is encoded in successive gamma cycles 60 Hz of a theta cycle 5 Hz (Lisman, J. E., & Idiart, M. A. P. (1995), Storage of 7±2 short-term memories in oscillatory subcycles, Science, 267, 1512-1515). Lisman and Idiart have proposed related mechanisms for precisely controlling spike timing, in which nodes undergo synchronous, sub-threshold oscillations of excitability. The amount of input to these nodes then determines the timing of firing with respect to this oscillatory cycle. That is, each activated letter unit fires in a burst for about 15 ms (one gamma cycle), and bursting repeats every 200 ms (one theta cycle). Activated letter units burst slightly out of phase with each other, such that they fire in a rapid sequence. This firing rapid sequence encoding (seriality) is the key point of abstraction.

In the present SERIOL model, the retinotopic presentation is mapped onto a temporal representation (space is mapped onto time) to create an abstract, invariant representation that provides a location-invariant representation of letter order. This abstract serial encoding provides input to both the lexical and sub-lexical routes. It is assumed that the sub-lexical route parses and translates the sequence of letters into a grapho-phonological encoding (Whitney, C., & Cornelissen, P. (2005), Letter-position encoding and dyslexia, Journal of Research in Reading, 28, 274-301). The resulting representation encodes syllabic structure and records which graphemes generated which phonemes. The remaining layers of the model address processing that is specific to the lexical route.

At the open-bigram layer, corresponding to the left middle fusiform, letter units recognize pairs of letter units that fire in a particular order (Grainger, J., & Whitney, C. (2004), Does the huamn mnid raed wrods as a whole?, Trends in Cognitive Sciences, 8, 58-59). For example, open-bigram unit XY is activated when letter unit X fires before Y, where the letters x and y were not necessarily contiguous in the string. The activation of an open-bigram unit decreases with increasing time between the firing of the constituent letter units. Thus, the activation of open-bigram XY is highest when triggered by contiguous letters, and decreases as the number of intervening letters increases. Priming data indicates that the maximum separation is likely to be two letters (Schoonbaert, S., & Grainger, J. (2004), Letter position coding in printed word perception: Effects of repeated and transposed letters, Language and Cognitive Processes, 19, 333-367). Open-bigram activations depend only on the distance between the constituent letters (Whitney, C. (2004a), Investigations into the neural basis of structured representations, Doctoral Dissertation. University of Maryland).

Still, following the evidence for a special role for external letters, the string is anchored to those endpoints via edge open-bigrams; whereby edge units explicitly encode the first and last letters (Humphreys, G. W., Evett, L. J., & Quinlan, P. T. (1990), Orthographic processing in visual word identification, Cognitive Psychology, 22, 517-560). For example, the encoding of the stimulus CART would be *C (open-bigram *C is activated when letter C is preceded by a space), CA, AR, CR, RT, AT, CT, and T* (open-bigram *T is activated when letter T is followed by a space), where * represents an edge or space. In contrast to other open-bigrams inside the string, an edge open-bigram cannot become partially activated (e.g., by the second or next-to-last letter).

At the word layer, the open-bigram units attach via weighted connections. The input to a word unit is represented by the dot-product of its respective number of open-bigram unit activations and the weighted connections to those open-bigrams units. Stated another way, it is the dot-product of the open-bigram unit's activation vector and the connection of the open-bigrams unit's weight vector. Commonly in neural networks models, the normalization of vector connection weights is assumed such that open-bigrams making up shorter words have higher connections weights than open-bigrams making up longer words. For example, the connection weights from CA, AN, and CN to the word-unit CAN are larger than the connections weights to the word-unit CANON. Hence, the stimulus can/would activate CAN more than CANON.

### Visual Perceptual Patterns

The SERIOL model assumes that the feature layer is comprised of features that are specific to alphanumeric-string serial processing. A stimulus would activate both alphanumeric-specific and general features. Alphanumeric-specific features would be subject to the locational gradient, while general features would reflect acuity. Alphanumeric-specific-features that activate alphanumeric representations would show the effects of string-specific serial processing. In particular, there will be an advantage if the letter or number character is the initial or last character of a string. However, if the symbol is not a letter or a number character, the alphanumeric-specific features will not activate an alphanumeric representation and there will be no alphanumeric-specific effects. Rather, the symbol will be recognized via the general visual features, where the effect of acuity predominates. An initial or last symbol in the string will be at a disadvantage because its acuity is lower than the acuity for the internal symbols in the string.

Two studies have examined visual perceptual patterns for letters versus non-alphanumeric characters in strings of centrally presented stimuli, using a between-subjects design for the different stimulus types (Hammond, E. J., & Green, D. W. (1982), Detecting targets in letter and non-letter arrays, Canadian Journal of Psychology, 36, 67-82). Both studies found an external-character advantage for letters. Specifically, the first and last letter characters were processed more efficiently than the internal letters characters. Mason also showed an external-character advantage for number strings (Mason, M. (1982), Recognition time for letters and non-letters: Effects of serial position, array size, and processing order, Journal of Experimental Psychology: Human Perception and Performance, 8, 724-738). However, both studies found that the advantage was absent for non-alphanumeric characters. The first and last symbol in a string were processed the least well in line with their lower acuity.

Using fixated strings containing both letters and non-alphanumeric characters, Tydgat and Grainger showed that an initial letter character in a string had a visual recognition advantage while an initial symbol (non-alphanumeric character) in the string did not. Thus, symbols that do not normally occur in strings show a different visual perceptual pattern than alphanumeric characters (Tydgat, I., and Grainger, J. (2009), Serial position effects in the identification of letters, digits, and symbols, J. Exp. Psychol. Hum. Percept. Perform. 35, 480-498). As described in more detail by Whitney & Cornelissen, the SERIOL model explains these visual perceptual patterns (Whitney, C., & Cornelissen, P. (2005), Letter-position encoding and dyslexia, Journal of Research in Reading, 28, 274-301; Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., & Cornelissen, P. (2005), Letter-position encoding and dyslexia, Journal of Research in Reading, 28, 274-301).

The external letter character advantage arises as follows. An advantage for the initial letter character in a string comes from the directional inhibition at the (retinotopic) feature level, because the initial letter character is the only letter character that does not receive lateral inhibition. An advantage for the final letter character arises at the (abstract) letter layer level, because the firing of the last letter character in a string is not terminated by a subsequent letter character. This serial positioning processing is specific to alphanumeric strings, thus explaining the lack of external character visual perceptual advantage for non-alphanumeric characters.

### Letter Position Parallel Encoding: The Grainger & Van Heuven Model

According to the Grainger and van Heuven model, parallel mapping of visual feature information at a specific location along the horizontal meridian with respect to eye fixation is mapped onto abstract letter representations that code for the presence of a given letter identity at that particular location (Grainger, J., & van Heuven, W. J. B. (2003), Modeling letter position coding in printed word perception, In P, Bonin (Ed.), Mental lexicon: “Some words to talk about words” (pp. 1-24). New York, N.Y.: Nova Science). In other words, this model proposes an “alphabetic array” retinotopic encoding consisting in a hypothesized bank of letter detectors that perform parallel, independent letter identification (any given letter has a separate representation for each retinal location). Grainger and van Heuven further proposed that these letters detectors are assumed to be invariant to the physical characteristics of letters and that these abstract letter representations are thought to be activated equally well by the same letter written in different case, in a different font, or a different size, but not invariant to position.

The next stage of processing, referred to as the “relative-position map”, is thought to code for the relative (within-stimulus) position of letters identities independently of their shape and their size, and independently of the location of the stimulus word (location invariance). This location-specific coding of letter identities is then transformed into a location invariant pre-lexical orthographic code (the relative-position map) before matching this information with whole-word orthographic representations in long-term memory. In essence, the relative-position map abstracts away from absolute letter position and focuses instead on relationships between letters. Therefore, in this model, the retinotopic alphabetic array is converted in parallel into an abstract open-bigram encoding that brings into play implicit relationships between letters. Specifically, this is achieved by open-bigram units that receive activation from the alphabetic array such that a given letter order D-E that is realized at any possible combinations of location in the retinotopic alphabetic array, activates the corresponding abstract open bigram for that sequence. Still, abstract open bigrams are activated by letter pairs that have up to two intervening letters. The abstract open-bigrams units then connect to word units. A key distinguishing virtue of this specific approach to letter position encoding rests on the assumption/claim that flexible orthographic coding is achieved by coding for ordered combinations of contiguous and non-contiguous letters pairs.

### Relationships Between Letters in a String—Coding Non-Contiguous Letter Combinations

Currently, there is a general consensus that the literate brain executes some form of word-centered, location-independent, orthographic coding such that letter identities are abstractly coded for their position in the word independent of their position on the retina (at least for words that require a single fixation for processing). This consensus also holds true for within-word position coding of letters identities to be flexible and approximate. In other words, letter identities are not rigidly allocated to a specific position. The corroboration for such flexibility and approximate orthographic encoding has been mainly classically obtained by utilizing the masked priming paradigm: for a given number of letters shared by the prime and target, priming effects are not affected by small changes of letter order (flexible and approximate letter position encoding)—transposed letter (TL) priming (Perea, M., and Lupker, S. J. (2004), Can CANISO activate CASINO? Transposed-letter similarity effects with nonadjacent letter positions, J. Mem. Lang. 51, 231-246; and Schoonbaert, S., and Grainger, J. (2004), Letter position coding in printed word perception: effects of repeated and transposed letters, Lang. Cogn. Process. 19, 333-367), and length-dependent letter position—relative-position priming (Peressotti, F., and Grainger, J. (1999), The role of letter identity and letter position in orthographic priming, Percept. Psychophys. 61, 691-706; and Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884).

Yet, the claim for a flexible and approximate orthographic encoding has extended to be also achieved by coding for letter combinations (Whitney, C., and Berndt, R. S. (1999), A new model of letter string encoding: simulating right neglect dyslexia, in Progress in Brain Research, eds J. A. Reggia, E. Ruppin, and D. Glanzman (Amsterdam: Elsevier), 143-163; Whitney, C. (2001), How the brain encodes the order of letters in a printed word: the SERIOL model and selective literature review, Psychon. Bull. Rev. 8, 221-243; Grainger, J., and van Heuven, W. J. B. (2003), Modeling letter position coding in printed word perception, in The Mental Lexicon, ed. P. Bonin (New York: Nova Science Publishers), 1-23; Dehaene, S., Cohen, L., Sigman, M., and Vinckier, F. (2005), The neural code for written words: a proposal, Trends Cogn. Sci. (Regul. Ed.) 9, 335-341). Letter combinations are classically and exclusively demonstrated by the use of contiguous letter combinations in n-gram coding and in particular by the use of non-contiguous letter combinations in n-gram coding. Dehaene has proposed that the coding of non-contiguous letter combinations arises as an artifact because of noisy erratic position retinotopic coding in location-specific letters detectors (Dehaene, S., Cohen, L., Sigman, M., and Vinckier, F. (2005), The neural code for written words: a proposal, Trends Cogn. Sci. (Regul. Ed.) 9, 335-341). In this scheme, the additional flexibility in orthographic encoding arises by accident, but the resulting flexibility is utilized to capture key data patterns.

In contrast, Dandurant has taken a different perspective, proposing that the coding of non-contiguous letter combinations is deliberate, and not the result of inaccurate location-specific letter coding (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In other words, non-contiguous letter combinations are coded because they are beneficial with respect to the overall goal of mapping letters onto meaning, not because the system is intrinsically noisy and therefore imprecise to determine the exact location of letters in a string. Dandurant et al., have examined two kinds of constrains that a reader should take into consideration when optimally processing orthographic information: 1) variations in letter visibility across the different letters of a word during a single fixation and 2) varying amount of information carried by the different letters in the word (e.g., consonants versus vowels letters). More specifically, they have hypothesized that this orthographic processing optimization would involve coding of non-contiguous letters combinations.

The reason for optimal processing of non-contiguous letter combinations can be explained on the following basis: 1) when selecting an ordered subset of letters which are critical to the identification of a word (e.g., the word “fatigue” can be uniquely identified by ordered letters substrings “ftge” and “atge” which result from dropping non-essential letters that bear little information), about half of the letters in the resulting subset are non-contiguous letters; and 2) the most informative pair of letters in a word is a non-contiguous pair of letters combination in 83% of 5-7 letter words (having no letter repetition) in English, and 78% in French and Spanish (the number of words included in the test set were 5838 in French, 8412 in English, and 4750 in Spanish) (Dandurant F., Grainger, J., Dunabeitia, J. A., & Granier, J.-p. (2011), On coding non-contiguous letter combinations, Frontiers in Psychology, 2(136), 1-12. Doi:10.3389/fpsyg.2011.00136). In summary, they concluded that an optimal and rational agent learning to read corpuses of real words should deliberately code for non-contiguous pair of letters (open-bigrams) based on informational content and given letters visibility constrains (e.g., initial, middle and last letters in an string of letters are more visually perceptually visible).

### Different Serial Position Effects in the Identification of Letters, Digits, and Symbols

In languages that use alphabetical orthographies, the very first stage of the reading process involves mapping visual features onto representations of the component letters of the currently fixated word (Grainger, J., Tydgat, I., and Isselé, J. (2010), Crowding affects letters and symbols differently, J. Exp. Psychol. Hum. Percept. Perform. 36, 673-688). Comparison of serial position functions using the target search task for letter stimuli versus symbol stimuli or simple shapes showed that search times for a target letter in a string of letters are represented by an approximate M-shape serial position function, where the shortest reaction times (RTs) were recorded for the first, third and fifth positions of a five-letter string (Estes, W. K., Allmeyer, D. H., & Reder, S. M. (1976), Serial position functions for letter identification at brief and extended exposure durations, Perception & Psychophysics, 19, 1-15). In contrast, a 5-symbol string (e.g., $, %, &) and shape stimuli shows a U-shape function with shortest RTs for targets at the central position on fixation that increase as a function of eccentricity (Hammond, E. J., & Green, D. W. (1982), Detecting targets in letter and non-letter arrays, Canadian Journal of Psychology, 36, 67-82).

A definitive interpretation of the different effect serial position has on letters and symbols is that it reflects the combination of two factors: 1) the drop of acuity from fixation to the periphery, and 2) less crowding on the first and last letter of the string because these letters are flanked by only one other letter (Bouma, H. (1973), Visual interference in the parafoveal recognition of initial and final letters of word, Vision Research, 13, 762-82). Specifically expanding on the second factor, Tydgat and Grainger proposed that crowding effects may be more limited in spatial extent for letter and number stimuli compared with symbol stimuli, such that a single flanking stimulus would suffice to generate almost maximum interference for symbols, but not for letters and numbers (Tydgat, I., and Grainger, J. (2009), Serial position effects in the identification of letters, digits, and symbols, J. Exp. Psychol. Hum. Percept. Perform. 35, 480-498). According to the Tydgat and Grainger interpretation of the different serial position functions for letters and symbols, one should be able to observe differential crowding effects for letters and symbols in terms of a superior performance at the first and last positions for letter stimuli but not for symbols or shapes stimuli. In a number of experiments they tested the hypothesis that a reduction in size of integration fields at the retinotopic layer, specific to stimuli that typically appear in strings (letters and digits), results in less crowding for such stimuli compared with other types of visual stimuli such as symbols and geometric shapes. In other words, the larger the integration field involved in identifying a given target at a given location, the greater the number of features from neighboring stimuli that can interfere in target identification. Stated another way, letter and digit stimuli benefit from a greater release from crowding effects (flanking letters or digits) at the outer positions than do symbol and geometric shape stimuli.

Still, critical spacing was found to be smaller for letters than for other symbols, with letter targets being identified more accurately than symbol targets at the lowest levels of inter-character spacing (manipulation of target-flankers spacing showed that symbols required a greater degree of separation [larger critical spacing] than letters in order to reach a criterion level of identification) (See experiment 5, Grainger, J., Tydgat, I., and Isselé, J. (2010), Crowding affects letters and symbols differently, J. Exp. Psychol. Hum. Percept. Perform. 36, 673-688). Most importantly, differential serial position crowding effects are of great importance given the fact that performance in the Two-Alternative Forced-Choice Procedure of isolated symbols and letters was very similar (Grainger, J., Tydgat, I., and Isselé, J. (2010), Crowding affects letters and symbols differently, J. Exp. Psychol. Hum. Percept. Perform. 36, 673-688).

Concerning the potential mechanism of crowding effects, Grainger et al. proposed bottom-up mechanisms whose operation can vary as a function of stimulus type via off-line as opposed to on-line influences. These off-line influences of stimulus type involved differences in perceptual learning driven by differential exposure to the different types of stimuli. Further, they proposed that when children learn to read, a specialized system develops in the visual cortex to optimize processing in the extremely crowded conditions that arise with printed words and numeric strings (e.g., in a two-stage retinotopic processing model: in the first-stage there is a detection of simple features in receptive fields of V1—0.1 ø and in a second-stage there is integration/interpretation in receptive fields of V4—0.5 ø [neurons in V4 are modulated by attention]) (See Levi, D. M., (2008), Crowding—An essential bottleneck for object recognition: A mini-review, Vision Research, 48, 635-654).

The central tenant here is that receptive field size of retinotopic letter and digit detectors has adapted to the need to optimize processing of strings of letters and digits and that the smaller the receptive field size of these detectors, the less interference there is from neighboring characters. One way to attain such processing optimization is being explained as a reduction in the size and shape of “integration fields.” The “integration field” is equivalent to a second-stage receptive field that combines the features by the earlier stage into an (object) alphanumeric character associated with location-specific letter detectors, “the alphabetic array”, that perform parallel letter identification compared with other visual objects that do not typically occur in such a cluttered environment (Dehaene, S., Cohen, L., Sigman, M., and Vinckier, F. (2005), The neural code for written words: a proposal, Trends Cogn. Sci. (Regul. Ed.) 9, 335-341; Grainger, J., Granier, J. P., Farioli, F., Van Assche, E., and van Heuven, W. J. B. (2006), Letter position information and printed word perception: the relative-position priming constraint, J. Exp. Psychol. Hum. Percept. Perform. 32, 865-884; and Grainger, J., and van Heuven, W. J. B. (2003), Modeling letter position coding in printed word perception, in The Mental Lexicon, ed. P. Bonin (New York: Nova Science Publishers), 1-23).

Ktori, Grainger, Dufau provided further evidence on differential effects between letters and symbols stimuli (Maria Ktori, Jonathan Grainger & Stéphane Dufau (2012), Letter string processing and visual short-term memory, The Quarterly Journal of Experimental Psychology, 65:3, 465-473). They study how expertise affects visual short-term memory (VSTM) item storage capacity and item encoding accuracy. VSTM is recognized as an important component of perceptual and cognitive processing in tasks that rest on visual input (Prime, D., &. Jolicoeur, P. (2010), Mental rotation requires visual short-term memory: Evidence from man electric cortical activity, Journal of Cognitive Neuroscience, 22, 2437-2446). Specifically, Prime and Jolicoeur investigated whether the spatial layout of letters making up a string affects the accuracy with which a group of proficient adult readers performed a change-detection task (Luck, S, J. (2008), Visual short-term memory, In S. J. Luck & A. Hollingworth (Eds.), Visual memory (pp. 43-85). New York, N.Y.: Oxford University Press), item arrays that varied in terms of character type (letters or symbols), number of items (3, 5, and 7), and type of display (horizontal, vertical and circular) are used. Study results revealed an effect of stimulus familiarity significantly noticeable in more accurate change-detection responses for letters than for symbols. In line with the hypothesized experimental goals in the study, they found evidence that supports that highly familiar items, such as arrays of letters, are more accurately encoded in VSTM than unfamiliar items, such as arrays of symbols. More so, their study results provided additional evidence that expertise is a key factor influencing the accuracy with which representations are stored in VSTM. This was revealed by the selective advantage shown for letter over symbol stimuli when presented in horizontal compared to vertical or circular displays formats. The observed selective advantage of letters over symbols can be the result of years of reading that leads to expertise in processing horizontally aligned strings of letters so as to form word units in alphabetic languages such as English, French and Spanish.

In summary, the study findings support the argument that letter string processing is significantly influenced by the spatial layout of letters in strings in perfect agreement with other studies findings conducted by Grainger & van Heuven (Grainger, & van Heuven, W. J. B. (2003), Modeling letter position coding in printed word perception, In P. Bonin (Ed.), Mental lexicon: “Some words to talk about words”, New York, N.Y.: Nova Science Publishers and Tydgat, L, & Grainger, J. (2009), Serial position effects in the identification of letters, digits and symbols, Journal of Experimental Psychology: Human Perception and Performance, 35, 480-498).

Open Proto-Bigrams Embedded within Words (Subset Words) and as Standalone Connecting Word in-Between Words

A number of computational models have postulated open-bigrams as best means to substantiate a flexible orthographic encoding capable of explaining TL and RP priming effects. In the Grainger & van Heuven model the retinotopic alphabetic array is converted in parallel into an abstract open-bigram encoding that brings into play implicit relationships between letters (e.g., contiguous and non-contiguous) (Grainger, J., & van Heuven, W. J. B. (2003), Modeling letter position coding in printed word perception, in P. Bonin (Ed.), Menial lexicon: “Some words to talk about words”. New York, N.Y.: Nova Science Publishers). In the SERIOL model retinotopic visual stimuli presentation is mapped onto a temporal one where letter units recognize pairs of letter units (an open-bigram) that fire in a particular serial order; namely, space is mapped onto time to create an abstract invariant representation providing a location-invariant representation of letter order in a string (Whitney, C. (2001a), How the brain encodes the order of letters in a printed word: The SERIOL model and selective literature review, Psychonomic Bulletin and Review, 8, 221-243; Whitney, C. (2008), Supporting the serial in the SERIOL model, Lang. Cogn. Process. 23, 824-865; and Whitney, C., and Cornelissen, P. (2005), Letter-position encoding and dyslexia, J. Res. Read. 28, 274-301). In these models, open-bigrams represent an abstract intermediary layer between letters and word units.

A key distinguishing virtue of this specific approach to letter position encoding rests on that flexible orthographic coding is achieved by coding for ordered combinations of contiguous and non-contiguous letters pairs, namely open-bigrams. For example, in the English language there are 676 pairs of letters combinations or open-bigrams (see Table 1 below). In addition to studies that have shown open-bigrams information processing differences between pair of letters entailing CC, VV, VC or CV, we introduce herein an additional open-bigrams novel property that should be interpreted as causing an automatic direct cascaded spread activation effect from orthography to semantics. Specifically, an open-bigram of the form VC or CV that is also a word carrying a semantic meaning such as for example: AM, AN, AS, AT, BE, BY, DO, GO, HE, IF, IN, IS, IT, ME, MY, NO, OF, ON, OR, SO, TO, UP, US, WE, is herein dubbed “open proto-bigram”. Still, these 24 open proto-bigrams that are also words represent 3.55% of all open-bigrams obtained from the English Language alphabet (see Table 1 below). Open proto-bigrams that are a subset word e.g., “BE” embedded in a word e.g., “BELOW” or are a subset word “HE” embedded in a superset word e.g., “SHE” or “THE” would not only indicate that the orthographic or phonological forms of the subset open proto-bigram word “HE” in the superset word “SHE” or “THE” or the subset open proto-bigram word “BE” in the word “BELOW” were activated in parallel, but also that these co-activated word forms triggered automatically and directly their corresponding semantic representations during the course of identifying the orthographic form of the word.

Based on the herein presented literature and novel teachings of the present subject matter, it is further assumed that this automatic bottom-up-top-down orthographic parallel-serial informational processing handshake, manifests in a direct cascade effect providing a number of advantages, thus facilitating the following perceptual-cognitive process: 1) fast lexical-sub-lexical recognition, 2) maximal chunking (data compression) of number of items in VSTM, 3) fast processing, 4) solid consolidation encoding in short-term memory (STM) and long-term memory (LTM), 5) fast semantic track for extraction/retrieval of word literal meaning, 6) less attentional cognitive taxing, 7) most effective activation of neighboring word forms, including multi-letter graphemes (e.g., th, ch) and morphemes (e.g., ing, er), 8) direct fast word recall that strongly inhibits competing or non-congruent distracting word forms; and 9) for a proficient reader, when open proto-bigrams are a standalone connecting a word unit in between words in a sentence, there is no need for (open proto-bigram) orthographic lexical pattern recognition and retrieval of their corresponding semantic literal information due to their super-efficient maximal chunking (data compression) and robust consolidation in STM-LTM. Namely, standalone open proto-bigrams connecting words in between words in sentences are automatically known implicitly. Thus, a proficient reader may also not consciously and explicitly pay attention to them and will therefore remain minimally aroused to their visual appearance.

TABLE 1
Open-Bigrams of the English Language

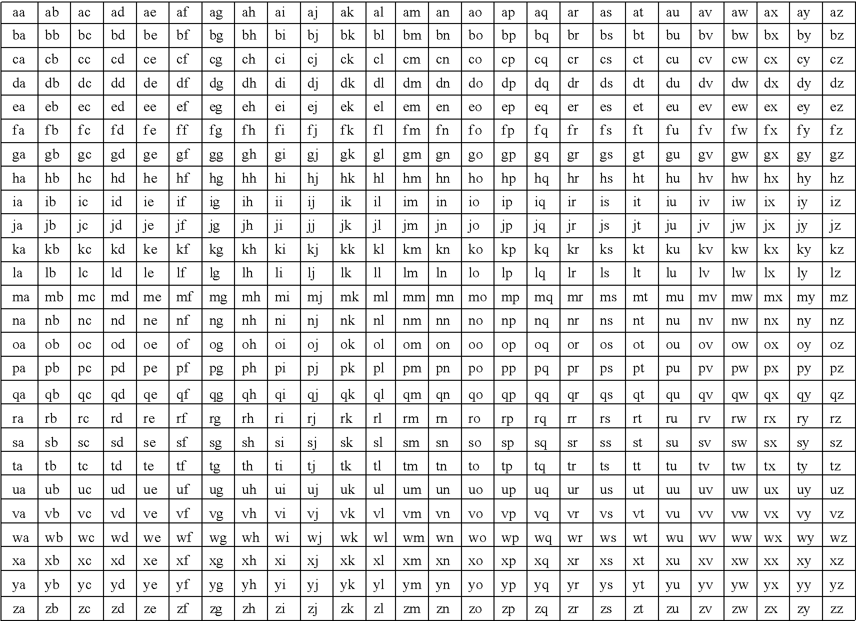

### Open Proto-Bigrams Words as Standalone Function Words in Between Words in Alphabetic Languages

Open-bigrams that are words (herein termed “open proto-bigrams), as for example: AM, AN, AS, AT, BE, BY, DO, GO, HE, IF, IN, IS, IT, ME, MY, NO, OF, ON, OR, SO, TO, UP, US, WE, belong to a linguistic class named ‘function words’. Function words either have reduced lexical or ambiguous meaning. They signal the structural grammatical relationship that words have to one another and are the glue that holds sentences together. Function words also specify the attitude or mood of the speaker. They are resistant to change and are always relatively few (in comparison to ‘content words’). Accordingly, open proto-bigrams (and other n-grams e.g. “THE”) words may belong to one or more of the following function words classes: articles, pronouns, adpositions, conjunctions, auxiliary verbs, interjections, particles, expletives and pro-sentences. Still, open proto-bigrams that are function words are traditionally categorized across alphabetic languages as belonging to a class named ‘common words’. In the English language, there are about 350 common words which stand for about 65-75% of the words used when speaking, reading and writing. These 350 common words satisfy the following criteria: 1) they are the most frequent/basic words of an alphabetic language; 2) they are the shortest words—up to 7 letters per word; and 3) they cannot be perceptually identified (access to their semantic meaning) by the way they sound; they must be recognized visually, and therefore are also named ‘sight words’.

Frequency Effects in Alphabetical Languages for: 1) Open bigrams and 2) Open Proto-Bigrams Function Words as: a) Standalone Function Words in Between Words and b) as Subset Function Words Embedded within Words

Fifty to 75% of the words displayed on a page or articulated in a conversation are frequent repetitions of most common words. Just 100 different most common words in the English language (see Table 2 below) account for a remarkable 50% of any written text. Further, it is noteworthy that 22 of the above-mentioned open proto-bigrams function words are also most common words that appear within the 100 most common words, meaning that on average one in any two spoken or written words would be one of these 100 most common words. Similarly, the 350 most common words account for 65% to 75% of everything written or spoken, and 90% of any average written text or conversation will only need a vocabulary of common 7,000 words from the existing 1,000,000 words in the English language.

TABLE 2
Most Frequently Used Words Oxford Dictionary 11^{Th} Edition

| | |
|---|---|
| 1. | the |
| 2. | be |
| 3. | to |
| 4. | of |
| 5. | and |
| 6. | a |
| 7. | in |
| 8. | that |
| 9. | have |
| 10. | I |
| 11. | it |
| 12. | for |
| 13. | not |
| 14. | on |
| 15. | with |
| 16. | he |
| 17. | as |
| 18. | you |
| 19. | do |
| 20. | at |
| 21. | this |
| 22. | but |
| 23. | his |
| 24. | by |
| 25. | from |
| 26. | they |
| 27. | we |
| 28. | say |
| 29. | her |
| 30. | she |
| 31. | or |
| 32. | an |
| 33. | will |
| 34. | my |
| 35. | one |
| 36. | all |
| 37. | would |
| 38. | there |
| 39. | their |
| 40. | what |
| 41. | so |
| 42. | up |
| 43. | out |
| 44. | if |
| 45. | about |
| 46. | who |
| 47. | get |
| 48. | which |
| 49. | go |
| 50. | me |
| 51. | when |
| 52. | make |
| 53. | can |
| 54. | like |
| 55. | time |
| 56. | no |
| 57. | just |
| 58. | him |
| 59. | know |
| 60. | take |
| 61. | person |
| 62. | into |
| 63. | year |
| 64. | your |
| 65. | good |
| 66. | some |
| 67. | could |
| 68. | them |
| 69. | see |
| 70. | other |
| 71. | than |
| 72. | then |
| 73. | now |
| 74. | look |
| 75. | only |
| 76. | come |
| 77. | its |
| 78. | over |
| 79. | think |
| 80. | also |
| 81. | back |
| 82. | after |
| 83. | use |
| 84. | two |
| 85. | how |
| 86. | our |
| 87. | work |
| 88. | first |
| 89. | well |
| 90. | way |
| 91. | even |
| 92. | new |
| 93. | want |
| 94. | because |
| 95. | any |
| 96. | these |
| 97. | give |
| 98. | day |
| 99. | most |
| 100. | us |

Most Frequently Used Words Oxford Dictionary 11^{th} Edition

Still, it is noteworthy that a large number of these 350 most common words entail 1 or 2 open pro-bigrams function words as embedded subset words within the most common word unit (see Table 3 below).

TABLE 3
Common Service and Nouns Words List
By: Edward William Dolch - Problems in Reading 1948
Dolch Word List Sorted Alphabetically by Grade with Nouns

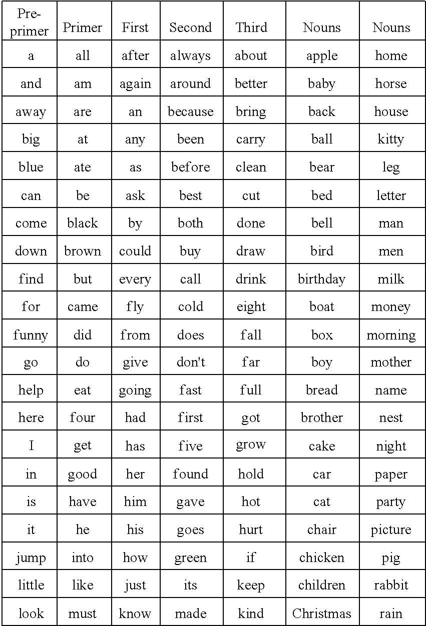

The teachings of the present subject matter are in perfect agreement with the fact that the brain's anatomical architecture constrains its perceptual-cognitive functional abilities and that some of these abilities become non-stable, decaying or atrophying with age. Indeed, slow processing speed, limited memory storage capacity, lack of sensory-motor inhibition and short attentional span and/or inattention, to mention a few, impose degrees of constrains upon the ability to visually, phonologically and sensory-motor implicitly pick-up, explicitly learn and execute the orthographic code. However, there are a number of mechanisms at play that develop in order to impose a number of constrains to compensate for limited motor-perceptual-cognitive resources. As previously mentioned, written words are visual objects before attaining the status of linguistic objects as has been proposed by McCandliss, Cohen, & Dehaene (McCandliss, B., Cohen, L., & Dehaene, S. (2003), The visual word form area: Expertise for reading in the fusiform gyrus, Trends in Cognitive Sciences, 13, 293-299) and there is pre-emption of visual object processing mechanisms during the process of learning to read (See also Dehaene et al., Local Combination Detector (LCD) model, Dehaene, S., Cohen, L., Sigman, M., and Vinckier, F. (2005), The neural code for written words: a proposal, Trends Cogn. Sci. (Regul. Ed.) 9, 335-341). In line with the latter, Grainger and van Heuven's alphabetic array is one such mechanism, described as a specialized system developed specifically for the processing of strings of alphanumeric stimuli (Grainger, J., & van Fleuven, W. J. B. (2003), Modeling letter position coding in printed word perception, In P. Bonin (Ed.), Mental lexicon: “Some words to talk about words”. New York, N.Y.: Nova Science Publishers).

Another such mechanism at work is the high lexical-phonological information redundancies conveyed in speech and also found in the lexical components of an alphabetic language orthographic code. For example, relationships among letter combinations within a string and in between strings reflect strong letter combinations redundancies. Thus, the component units of the orthographic code implement frequent repetitions of some open bigrams in general and of all open proto-bigrams (that are words) in particular. In general, lexical and phonological redundancies in speech production and lexical redundancies in writing as reflected in frequent repetitions of some open bigrams and all open proto-bigrams within a string (a word) and among strings (words) in sentences reduces content errors in sender production of written-spoken messages making the spoken phonological-lexical message or orthographic code message resistant to noise or irrelevant contextual production substitutions, thereby increasing the interpretational semantic probability to comprehending the received message in its optimal context by the receiver.

Despite the above-mentioned brain anatomical constrains on function and related limited motor-perceptual-cognitive resources and how these constrains impact the handling of orthographic information, the co-occurrence of some open-bigrams and all open proto-bigrams in alphabetic languages renders alongside other developed compensatory specialized mechanisms at work (e.g. alphabetic array) an offset strategy that implements age-related, fast, coarse-lexical pattern recognition, maximal chunking (data compression) and optimal manipulation of alphanumeric-items in working memory-short-term memory (WM-STM), direct and fast access from lexical to semantics, robust semantic word encoding in STM-LTM and fast (non-aware) semantic word retrieval from LTM. On the other hand, the low co-occurrence of some open-bigrams in a word represent rare (low probability) letter combination events, and therefore are more informative concerning the specific word identity than frequent (predictable) occurring open-bigrams letter combination events in a word (Shannon, C. E. (1948), A mathematical theory of communication, Bell Syst. Tech. J. 27, 379-423). In brief, the low co-occurrence of some open-bigrams conveys most information that determines word identity (diagnostic feature).

Grainger and Ziegler explained that both types of constraints are driven by the frequency with which different combinations of letters occur in printed words. On one hand, frequency of occurrence determines the probability with which a given combination of letters belongs to the word being read. Letter combinations that are encountered less often in other words are more diagnostic (an informational feature that renders ‘word identity’) than the identity of the word being processed. In the extreme, a combination of letters that only occurs in a single word in the language, and is therefore a rarely occurring combination of letters event when considering the language as a whole, is highly informative with respect to word identity. On the other hand, the co-occurrence (high frequency of occurrence) enables the formation of higher-order representations (maximal chunking) in order to diminish the amount of information that is processed via data compression. Letter combinations (e.g., open-bigrams and trigrams) that often occur together can be usefully grouped to form higher-level orthographic representations such as multi-letter graphemes (th, ch) and morphemes (ing, er), thus providing a link with pre-existing phonological and morphological representations during reading acquisition (Grainger, J., & Ziegler, J. C. (2011), a Dual-Route Approach to Orthographic Processing, Frontiers in Psychology, 2(54), 1-13).

The teachings of the present invention claim that open proto-bigram words are a special class/kind of coarse-grained orthographic code that computes (at the same time/in parallel) occurrences of contiguous and non-contiguous letters combinations (conditional probabilities of one or more subsets of open proto-bigram word(s)) within words and in between words (standalone open proto-bigram word) in order to rapidly hone in on a unique informational word identity alongside the corresponding semantic related representations, namely the fast lexical track to semantics (and correlated mental sensory-motor representation-simulation that grounds the specific semantic (word) meaning to the appropriate action).

### Aging and Language

Early research on cognitive aging has pointed out that language processing was spared in old age, in contradistinction to the decline in “fluid” (e.g. reasoning) intellectual abilities, such as remembering new information and in (sensory-motor) retrieving orthographic-phonologic knowledge (Botwinick, J. (1984), Aging and Behavior. New York: Springer). Still, research in this field strongly supports a general asymmetry in the effects of aging on language perception-comprehension versus production (input versus output processes). Older adults exhibit clear deficits in retrieval of phonological and lexical information from speech alongside retrieval of orthographic information from written language, with no corresponding deficits in language perception and comprehension, independent of sensory and new learning deficits. The input side of language includes visual perception of the letters and corresponding speech sounds that make up words and retrieval of semantic and syntactic information about words and sentences. These input-side language processes are commonly referred to as “language comprehension,” and they remain remarkably stable in old age, independent of age-linked declines in sensory abilities (Madden, D. J. (1988), Adult age differences in the effects of sentence context and stimulus degradation during visual word recognition, Psychology and Aging, 3, 167-172) and memory for new information (Light, L., & Burke, D. (1988), Patterns of language and memory in old age, In L. Light, & D. Burke, (Eds.), Language, memory and aging (pp. 244-271). New York: Cambridge University Press; Kemper, S. (1992b), Language and aging, In F. I. M. Craik & T. A. Salthouse (Eds.) The handbook of aging and cognition (pp. 213-270). Hillsdale, N.J.: Lawrence Erlbaum Associates; and Tun, P. A., & Wingfield, A. (1993), Is speech special? Perception and recall of spoken language in complex environments, In J. Cerella, W. Hoyer, J. Rybash, & M. L. Commons (Eds.) Adult information processing: Limits on loss (pp. 425-457) San Diego: Academic Press).

Tasks highlighting language comprehension processes, such as general knowledge and vocabulary scores in tests such as the Wechsler Adult Intelligence Scale, remain stable or improve with aging and provided much of the data for earlier conclusions about age constancy in language perception-comprehension processes. (Botwinick, J. (1984), Aging and Behavior, New York: Springer; Kramer, N. A., & Jarvik, L. F. (1979), Assessment of intellectual changes in the elderly, In A. Raskin & L. F. Jarvik (Eds.), Psychiatric symptoms and cognitive loss in the elderly (pp. 221-271). Washington, D.C.: Hemisphere Publishing; and Verhaeghen, P. (2003), Aging and vocabulary scores: A meta-analysis, Psychology and Aging, 18, 332-339). The output side of language involves retrieval of lexical and phonological information during everyday language production and retrieval of orthographic information such as unit components of words, during every day sensory-motor writing and typing activities. These output-side language processes, commonly termed “language production,” do exhibit age-related dramatic performance declines.

Aging has little effect on the representation of semantic knowledge as revealed, for example, by word associations (Burke, D., & Peters, L. (1986), Word associations in old age: Evidence for consistency in semantic encoding during adulthood, Psychology and Aging, 4, 283-292), script generation (Light, L. L., & Anderson, P. A. (1983), Memory for scripts in young and older adults, Memory and Cognition, 11, 435-444), and the structure of taxonomic categories (Howard, D. V. (1980), Category norms: A comparison of the Battig and Montague (1960) norms with the responses of adults between the ages of 20 and 80, Journal of Gerontology, 35, 225-231; and Mueller, J. H., Kausler, D. H., Faherty, A., & Oliveri, M. (1980), Reaction time as a function of age, anxiety, and typicality, Bulletin of the Psychonomic Society, 16, 473-476). Because comprehension involves mapping language onto existing knowledge structures, age constancy in the nature of these structures is important for maintaining language comprehension in old age. There is no age decrement in semantic processes in comprehension for both off-line and online measures of word comprehension in sentences (Speranza, F., Daneman, M., & Schneider, B. A. (2000) How aging affects reading of words in noisy backgrounds, Psychology and Aging, 15, 253-258). For example, the comprehension of isolated words in the semantic priming paradigm, particularly, the reduction in the time required to identify a target word (TEACHER) when it follows a semantically related word, (STUDENT) rather than a semantically unrelated word (GARDEN); here, perception of STUDENT primes semantically related information, automatically speeding recognition of TEACHER; and such semantic priming effects are at least as large in older adults as they are in young adults (Balota, D. A, Black, S., & Cheney, M. (1992), Automatic and attentional priming in young and older adults: Reevaluation of the two process model, Journal of Experimental Psychology: Human Perception and Performance, 18, 489-502; Burke, D., White, H., & Diaz, D. (1987), Semantic priming in young and older adults: Evidence for age-constancy in automatic and attentional processes, Journal of Experimental Psychology: Human Perception and Performance, 13, 79-88; Myerson, J. Ferraro, F. R., Hale, S., & Lima, S. D. (1992), General slowing in semantic priming and word recognition, Psychology and Aging, 7, 257-270; and Laver, G. D., & Burke, D. M. (1993), Why do semantic priming effects increase in old age? A meta-analysis, Psychology and Aging, 8, 34-43). Similarly, sentence context also primes comprehension of word meanings to an equivalent extent for young and older adults (Burke, D. M., & Yee, P. L. (1984), Semantic priming during sentence processing by young and older adults, Developmental Psychology, 20, 903-910; and Stine, E. A. L., & Wingfield, A. (1994), Older adults can inhibit high probabilitycompetitors in speech recognition, Aging and Cognition, 1, 152-157).

By contrast to the age constancy in comprehending semantic word meaning, extensive experimental research shows age-related declines in retrieving a name (less accurate and slower) corresponding to definitions, pictures or actions (Au, R., Joung, P., Nicholas, M., Obler, L. K., Kass, R. & Albert, M. L. (1995), Naming ability across the adult life span, Aging and Cognition, 2, 300-311; Bowles, N. L., & Poon, L. W. (1985), Aging and retrieval of words in semantic memory, Journal of Gerontology, 40, 71-77; Nicholas, M., Obler, L., Albert, M., & Goodglass, H. (1985), Lexical retrieval in healthy aging, Cortex, 21, 595-606; and Goulet, P., Ska, B., & Kahn, H. J. (1994), Is there a decline in picture naming with advancing age?, Journal of Speech and Hearing Research, 37, 629-644) and in the production of a target word given its definition and initial letter, or given its initial letter and general semantic category (McCrae, R. R., Arenberg, D., & Costa, P. T. (1987), Declines in divergent thinking with age: Cross-sectional, longitudinal, and cross-sequential analyses, Psychology and Aging, 2, 130-137).

Older adults rated word finding failures and tip of the tongue experiences (TOTs) as cognitive problems that are both most severe and most affected by aging (Rabbitt, P., Maylor, E., McInnes, L., Bent, N., & Moore, B. (1995), What goods can self-assessment questionnaires deliver for cognitive gerontology?, Applied Cognitive Psychology, 9, S127-S152; Ryan, E. B., See, S. K., Meneer, W. B., & Trovato, D. (1994), Age-based perceptions of conversational skills among younger and older adults, In M. L. Hummert, J. M. Wiemann, & J. N. Nussbaum (Eds.) Interpersonal communication in older adulthood (pp. 15-39). Thousand Oaks, Calif.: Sage Publications; and Sunderland, A., Watts, K., Baddeley, A. D., & Harris, J. E. (1986), Subjective memory assessment and test performance in the elderly, Journal of Gerontology, 41, 376-384). Older adults rated retrieval failures for proper names as especially common (Cohen, G., & Faulkner, D. (1984), Memory in old age: “good in parts” New Scientist, 11, 49-51; Martin, M. (1986); Ageing and patterns of change in everyday memory and cognition, Human Learning, 5, 63-74; and Ryan, E. B. (1992), Beliefs about memory changes across the adult life span, Journal of Gerontology: Psychological Sciences, 47, P 41-P 46) and the most annoying, embarrassing and irritating of their memory problems (Lovelace, E. A., & Twohig, P. T. (1990), Healthy older adults' perceptions of their memory functioning and use of mnemonics, Bulletin of the Psychonomic Society, 28, 115-118). They also produce more ambiguous references and pronouns in their speech, apparently because of an inability to retrieve the appropriate nouns (Cooper, P. V. (1990), Discourse production and normal aging: Performance on oral picture description tasks, Journal of Gerontology: Psychological Sciences, 45, P 210-214; and Heller, R. B., & Dobbs, A. R. (1993), Age differences in word finding in discourse and nondiscourse situations, Psychology and Aging, 8, 443-450). Speech disfluencies, such as filled pauses and hesitations, increase with age and may likewise reflect word retrieval difficulties (Cooper, P. V. (1990), Discourse production and normal aging: Performance on oral picture description tasks, Journal of Gerontology: Psychological Sciences, 45, P210-214; and Kemper, S. (1992a), Adults' sentence fragments: Who, what, when, where, and why, Communication Research, 19, 444-458).

Further, TOT states increase with aging, accounting for one of the most dramatic instances of word finding difficulty in which a person is unable to produce a word although absolutely certain that they know it. Both naturally occurring TOTs (Burke, D. M., MacKay, D. G., Worthley, J. S., & Wade, E. (1991), On the tip of the tongue: What causes word finding failures in young and older adults, Journal of Memory and Language, 30, 542-579) and experimentally induced TOTs increase with aging (Burke, D. M., MacKay, D. G., Worthley, J. S., & Wade, E. (1991), On the tip of the tongue: What causes word finding failures in young and older adults, Journal of Memory and Language, 30, 542-579; Brown, A. S., & Nix, L. A. (1996), Age-related changes in the tip-of-the-tongue experience, American Journal of Psychology, 109, 79-91; James, L. E., & Burke, D. M. (2000), Phonological priming effects on word retrieval and tip-of-the-tongue experiences in young and older adults, Journal of Experimental Psychology: Learning. Memory, and Cognition, 26, 1378-1391; Maylor, E. A. (1990b), Recognizing and naming faces: Aging, memory retrieval and the tip of the tongue state, Journal of Gerontology: Psychological Sciences, 45, P 215-P 225; and Rastle, K. G., & Burke, D. M. (1996), Priming the tip of the tongue: Effects of prior processing on word retrieval in young and older adults, Journal of Memory and Language, 35, 586-605).

Still, word retrieval failures in young and especially older adults appear to reflect declines in access to phonological representations. Evidence for age-linked declines in language production has come almost exclusively from studies of word retrieval. MacKay and Abrams reported that older adults made certain types of spelling errors more frequently than young adults in written production, a sub-lexical retrieval deficit involving orthographic units (MacKay, D. G., Abrams, L., & Pedroza, M. J. (1999), Aging on the input versus output side: Theoretical implications of age-linked asymmetries between detecting versus retrieving orthographic information, Psychology and Aging, 14, 3-17). This decline occurred despite age equivalence in the ability to detect spelling errors and despite the higher vocabulary and education levels of older adults. The phonological/orthographic knowledge retrieval problem in old age is not due to deficits in formulating the idea to be expressed, but rather it appears to reflect an inability to map a well-defined idea or lexical concept onto its phonological and orthographic unit forms. Thus, unlike semantic comprehension of word meaning, which seems to be well-preserved in old age, sensory-motor retrieval of phonological and orthographic representations declines with aging.

### Language Production Deficits in Normal Aging and Open-Bigrams and Open Proto-Bigrams Priming

The teachings of the present invention are in agreement with some of the mechanisms and predictions of the transmission deficit hypothesis (TDH) computational model (Burke, D. M., Mackay, D. G., & James L. E. (2000), Theoretical approaches to language and aging, In T. J. Perfect & E. A. Maylor (Eds.), Models of cognitive aging (pp. 204-237). Oxford, England: Oxford University Press; and MacKay, D. G., & Burke, D. M. (1990), Cognition and aging: A theory of new learning and the use of old connections, In T. M. Hess (Ed.), Aging and cognition: Knowledge organization and utilization (pp. 213-263). Amsterdam: North Holland). Briefly, under the TDH, verbal information is represented in a network of interconnected units or nodes organized into a semantic system representing lexical and propositional meaning and a phonological system representing sounds. In addition to these nodes, there is a system of orthographic nodes with direct links to lexical nodes and also lateral links to corresponding phonological nodes (necessary for the production of novel words and pseudowords). In the TDH, language word comprehension (input) versus word production (output) differences arise from an asymmetrical structure of top-down versus bottom-up priming connections to the respective nodes.

In general, the present invention stipulates that normal aging weakens the priming effects of open-bigrams in words, particularly open proto-bigrams inside words and in between words in a sentence or fluent speech. This weakening priming effect of open proto-bigrams negatively impacts the direct lexical to semantics access route for automatically knowing the most common words in a language, and in particular, causes slow, non-accurate (spelling mistakes) recognition and retrieval of the orthographic code via writing and typing as well as slow, non-accurate (errors) or TOT of phonological and lexical information concerning particular types of naming word retrievals from speech. It is worth noticing that with aging, this priming weakening effect of open-bigrams and open proto-bigrams greatly diminishes the benefits of possessing a language with a high lexical-phonological information and lexical orthographic code representation redundancy. Therefore, it is to be expected that older individuals will increase content production errors in written-spoken messages, making phonological and lexical information via speech naming retrieval, and/or lexical orthographic production via writing, less resistant to noise. In other words, the early language advantage resting upon a flexible orthographic code and a flexible lexical-phonological informational encoding of speech becomes a disadvantage with aging since the orthographic or lexical-phonological code will become too flexible and prompt too many production errors.

The teachings of the present invention point out that language production deficits, particularly negatively affecting open-bigrams and open proto-bigrams when aging normally, promote an inefficient and noisy sensory-motor grounding of cognitive (top-down) fluent reasoning/intellectual abilities reflected in slow, non-accurate or wrong substitutions of ‘naming meaning’ in specific domains (e.g., names of people, places, dates, definitions, etc.) The teachings of the present invention further hypothesize that in a mild to severe progression Alzheimer's or dementia individual, language production deficits worsen and expand to also embrace wrong or non-sensory-motor grounding of cognitive (top-down) fluent reasoning/intellectual abilities thus causing a partial or complete informational disconnect/paralysis between object naming retrieval and the respective action-use domain of the retrieved object.

### A Novel Neuro-Performance Non-Pharmacological Alphabetic Language Based Technology

Without limiting the scope of the present invention, the teachings of the present invention disclose a non-pharmacological technology aiming to promote novel exercising of alphanumeric symbolic information. The present invention aims for a subject to problem solve and perform a broad spectrum of relationships among alphanumeric characters. For that purpose, direct and inverse alphabetical strings are herein presented comprising a constrained serial positioning order among the letter characters as well as randomized alphabetical strings comprising a non-constrained alphabetical serial positioning order among the letter characters. The herein presented novel exercises involve visual and/or auditory searching, identifying/recognizing, sensory-motor selecting and organizing of one or more open-bigrams and/or open proto-bigrams in order to promote fluid reasoning ability in a subject manifested in an effortless, fast and efficient problem solving of particular letter characters relationships in direct-inverse alphabetical and/or randomized alphabetical sequences. Still, the herein non-pharmacological technology, consist of novel exercising of open-bigrams and open proto-bigrams to promote: a) a strong grounding of lexical-phonological cognitive information in spoken language and of lexical orthographic unit components in writing language, b) a language neuro-prophylactic shielding against language production processing deficits in normal aging population, c) a language neuro-prophylactic shielding against language production processing deficits in MCI people, and d) a language neuro-prophylactic shielding against language production processing deficits capable of slowing down (or reversing) early mild neural degeneration cognitive adversities in Alzheimer's and dementia individuals.

Orthographic Sequential Encoded Regulated by Inputs to Oscillations within Letter Units (‘SERIOL’) Processing Model:

According to the SERIOL processing model, orthographic processing occurs at two levels—the neuronal level, and the abstract level. At the neuronal level, orthographic processing occurs progressively beginning from retinal coding (e.g., string position of letters within a string), followed by feature coding (e.g., lines, angles, curves), and finally letter coding (coding for letter nodes according to temporal neuronal firing.) At the abstract level, the coding hierarchy is (open) bigram coding (i.e., sequential ordered pairs of letters—correlated to neuronal firings according to letter nodes) followed by word coding (coding by: context units—words represented by visual factors—serial proximity of constituent letters). ((Whitney, C. (2001a), How the brain encodes the order of letters in a printed word: The SERIOL model and selective literature review, Psychonomic Bulletin and Review, 8, 221-243).

Some Statistical Aspects of Sequential Order of Letters and Letter Strings:

In the English language, in a college graduate vocabulary of about 20,000 letter strings (words), there are about only 50-60 words which obey a direct A-Z or indirect Z-A sequential incomplete alphabetical different letters serial order (e.g., direct A-Z “below” and inverse Z-A “the”). More so, about 40% of everything said, read or written in the English language consists of frequent repetitions of open proto-bigrams (e.g., is, no, if, or etc.) words in between words in written sentences or uttered words in between uttered words in a conversation. In the English language, letter trigrams frequent repetitions (e.g. “the”, ‘can’, ‘his’, ‘her’, ‘its’, etc.) constitute more than 10% of everything said, read or written.

### Methods

The definition given to the terms below is in the context of their meaning when used in the body of this application and in its claims.

The below definitions, even if explicitly referring to letters sequences, should be considered to extend into a more general form of these definitions to include numerical and alphanumerical sequences, based on predefined complete numerical and alphanumerical set arrays and a formulated meaning for pairs of non-equal and non-consecutive numbers in the predefined set array, as well as for pairs of alphanumeric characters of the predefined set array.

A “series” is defined as an orderly sequence of terms

“Serial terms” are defined as the individual components of a series.

A “serial order” is defined as a sequence of terms characterized by: (a) the relative ordinal spatial position of each term and the relative ordinal spatial positions of those terms following and/or preceding it; (b) its sequential structure: an “indefinite serial order,” is defined as a serial order where no first neither last term are predefined; an “open serial order.” is defined as a serial order where only the first term is predefined; a “closed serial order,” is defined as a serial order where only the first and last terms are predefined; and (c) its number of terms, as only predefined in ‘a closed serial order’.

“Terms” are represented by one or more symbols or letters, or numbers or alphanumeric symbols.

“Arrays” are defined as the indefinite serial order of terms. By default, the total number and kind of terms are undefined.

“Terms arrays” are defined as open serial orders of terms. By default, the total number and kind of terms are undefined.

“Set arrays” are defined as closed serial orders of terms, wherein each term is intrinsically a different member of the set and where the kinds of terms, if not specified in advance, are undefined. If, by default, the total number of terms is not predefined by the method(s) herein, the total number of terms is undefined.

“Letter set arrays” are defined as closed serial orders of letters, wherein same letters may be repeated.

An “alphabetic set array” is a closed serial order of letters, wherein all the letters are predefined to be different (not repeated). Still, each letter member of an alphabetic set array has a predefined different ordinal position in the alphabetic set array. An alphabetic set array is herein considered to be a Complete Non-Randomized alphabetical letters sequence. Letter symbol members are herein only graphically represented with capital letters. For single letter symbol members, the following complete 3 direct and 3 inverse alphabetic set arrays are herein defined:

Direct alphabetic set array: A, B, C, D, E, F, G, H, I, J, K, L, M, N, O, P, Q, R, S, T, U, V, W, X, Y, Z.

Inverse alphabetic set array: Z, Y, X, W, V, U, T, S, R, Q, P, O, N, M, L, K, J, I, H, G, F, E, D, C, B, A.

Direct type alphabetic set array: A, Z, B, Y, C, X, D, W, E, V, F, U, G, T, H, S, I, R, J, Q, K, P, L, O, M, N.

Inverse type alphabetic set array: Z, A, Y, B, X, C, W, D, V, E, U, F, T, G, S, H, R, I, Q, J, P, K, O, L, N, M.

Central type alphabetic set array: A, N, B, O, C, P, D, Q, E, R, F, S, G, T, H, U, I, V, J, W, K, X, L, Y, M, Z.

Inverse central type alphabetic set array: N, A, O, B, P, C, Q, D, R, E, S, F, T, G, U, H, V, I, W, J, X, K, Y, L, Z, M.

An “open bigram,” if not specified otherwise, is herein defined as a closed serial order formed by any two contiguous or non-contiguous letters of the above alphabetic set arrays. Under the provisions set forth above, an “open bigram” may also refer to pairs of numerical or alpha-numerical symbols.

For Alphabetic Set Arrays where the Members are Defined as Open bigrams, the Following 3 Direct and 3 Inverse Alphabetic Open bigrams Set Arrays are Herein Defined

Direct alphabetic open bigram set array: AB, CD, EF, GH, U, KL, MN, OP, QR, ST, UV, WX, YZ.

Inverse alphabetic open bigram set array: ZY, XW, VU, TS, RQ, PO, NM, LK, JI, HG, FE, DC, BA.

Direct alphabetic type open bigram set array: AZ, BY, CX, DW, EV, FU, GT, HS, IR, JQ, KP, LO, MN.

Inverse alphabetic type open bigram set array: ZA, YB, XC, WD, VE, UF, TG, SH, RI, QJ, PK, OL, NM.

Central alphabetic type open bigram set array: AN, BO, CP, DQ, ER, FS, GT, HU, IV, JW, KX, LY, MZ.

Inverse alphabetic central type open bigram set array: NA, OB, PC, QD, RE, SF, TG, UH, VI, WJ, XK, YL, ZM.

An “open bigram term” is a lexical orthographic unit characterized by a pair of letters (n-gram) depicting a minimal sequential order consisting of two letters. The open bigram class to which an open bigram term belongs may or may not convey an automatic direct access to semantic meaning in an alphabetic language to a reader.

An “open bigram term sequence” is a letters symbol sequence, where two letter symbols are presented as letter pairs representing a term in the sequence, instead of an individual letter symbol representing a term in the sequence.

There are 4 classes of Open bigram terms, there being a total of 676 different open bigram terms in the English alphabetical language

Class I—Within the context of the present subject matter, Class I always refers to “open proto-bigram terms”. Specifically, there are 24 open proto-bigram terms in the English alphabetical language.

Class II—Within the context of the present subject matter, Class II consists of open bigram terms entailed in alphabetic open bigram set arrays (6 of these alphabetic open bigram set arrays are herein defined for the English alphabetical language). Specifically, Class II comprises a total of 78 different open bigram terms wherein 2 open bigram terms are also open bigram terms members of Class I.

Class III—Within the context of the present subject matter, Class III entails the vast majority of open bigram terms in the English alphabetical language except for all open bigram terms members of Classes I, II, and IV. Specifically, Class III comprises a total of 550 open bigram terms.

Class IV—Within the context of the present subject matter, Class IV consists of open bigram terms entailing repeated single letters symbols. For the English alphabetical language, Class IV comprises a total of 26 open bigram terms.

An alphabetic “open proto-bigram term” (see Class I above) is defined as a lexical orthographic unit characterized by a pair of letters (n-gram) depicting the smallest sequential order of contiguous and non-contiguous different letters that convey an automatic direct access to semantic meaning in an alphabetical language (e.g., English alphabetical language: an, to, so etc.).

An “open proto-bigram sequence type” is herein defined as a complete alphabetic open proto-bigram sequence characterized by the pairs of letters comprising each open proto-bigram term in a way that the serial distribution of such open proto-bigram terms establishes a sequence of open proto-bigram terms type that follows a direct or an inverse alphabetic set array order. In summary, there are two complete alphabetic open proto-bigram sequence types.

Types of Open Proto-Bigram Sequences:

Direct type open proto-bigram sequence: AM, AN, AS, AT, BE, BY, DO, GO, IN, IS, IT, MY, NO, OR

Inverse type open proto-bigram sequence: WE, US, UP, TO, SO, ON, OF, ME, IF, HE.

“Complete alphabetic open proto-bigram sequence groups” within the context of the present subject matter, Class I open-proto bigram terms, are further grouped in three sequence groups:

Open Proto-Bigram Sequence Groups:

Left Group: AM, BE, HE, IF, ME

Central Group: AN, AS, AT, BY, DO, GO, IN, IS, IT, MY, OF, WE

Right Group: NO, ON, OR, SO, TO, UP, US

The term “collective critical space” is defined as the alphabetic space in between two non-contiguous ordinal positions of a direct or inverse alphabetic set array. A “collective critical space” further corresponds to any two non-contiguous letters which form an open proto-bigram term. The postulation of a “collective critical space” is herein contingent to any pair of non-contiguous letter symbols in a direct or inverse alphabetic set array, where their orthographic form directly and automatically conveys a semantic meaning to the subject.

The term “virtual sequential state” is herein defined as an implicit incomplete alphabetic sequence made-up of the letters corresponding to the ordinal positions entailed in a “collective critical space”. There is at least one implicit incomplete alphabetic sequence entailed per each open proto-bigram term. These implicit incomplete alphabetic sequences are herein conceptualized to exist in a virtual perceptual-cognitive mental state of the subject. Every time that this virtual perceptual-cognitive mental state is grounded by means of a programmed goal oriented sensory-motor activity in the subject, his/her reasoning and mental cognitive ability is enhanced.

From the above definitions, it follows that a letters sequence, which at least entails two non-contiguous letters forming an open proto-bigram term, will possess a “collective critical spatial perceptual related attribute” as a direct consequence of the implicit perceptual condition of the at least one incomplete alphabetic sequence arising from the “virtual sequential state” in correspondence with the open proto-bigram term This virtual/abstract serial state becomes concrete every time a subject is required to reason and perform goal oriented sensory motor action to problem solve a particular kind of serial order involving relationships among alphabetic symbols in a sequence of symbols. One way of promoting this novel reasoning ability is achieved through a predefined goal oriented sensory motor activity of the subject by performing a data “compression” of a selected letters sequence or by performing a data “expansion” of a selected letters sequence in accordance with the definitions of the terms given below.

Moreover, as already indicated above for a general form of these definitions, for a predefined Complete Numerical Set Array and a predefined Complete Alphanumeric Set Array, the “collective critical space”, “virtual sequential state” and “collective critical spatial perceptual related attribute” for alphabetic series can also be extended to include numerical and alphanumerical series.

An “ordinal position” is defined as the relative position of a term in a series, in relation to the first term of this series, which will have an ordinal position defined by the first integer number (#1), and each of the following terms in the sequence with the following integer numbers (#2, #3, #4, . . . ). Therefore, the 26 different letter terms of the English alphabet will have 26 different ordinal positions which, in the case of the direct alphabetic set array (see above), ordinal position #1 will correspond to the letter “A”, and ordinal position #26 will correspond to the letter “Z”.

An “alphabetic letter sequence,” unless otherwise specified, is herein one or more complete alphabetic letter sequences from the group comprising: Direct alphabetic set array, Inverse alphabetic set array, Direct open bigram set array, Inverse open bigram set array, Direct open proto-bigram sequence, and Inverse open proto-bigram sequence.

The term “incomplete” serial order refers herein only in relation to a serial order which has been previously defined as “complete.”

As used herein, the term “relative incompleteness” is used in relation to any previously selected serial order which, for the sake of the intended task herein required performing by a subject, the said selected serial order could be considered to be complete.

As used herein, the term “absolute incompleteness” is used only in relation to alphabetic set arrays, because they are defined as complete closed serial orders of terms (see above). For example, in relation to an alphabetic set array, incompleteness is absolute, involving at the same time: number of missing letters, type of missing letters and ordinal positions of missing letters.

A “non-alphabetic letter sequence” is defined as any letter series that does not follow the sequence and/or ordinal positions of letters in any of the alphabetic set arrays.

A “symbol” is defined as a mental abstract graphical sign/representation, which includes letters and numbers.

A “letter term” is defined as a mental abstract graphical sign/representation, which is generally, characterized by not representing a concrete: thing/item/form/shape in the physical world. Different languages may use the same graphical sign/representation depicting a particular letter term, which it is also phonologically uttered with the same sound (like “s”).

A “letter symbol” is defined as a graphical sign/representation depicting in a language a letter term with a specific phonological uttered sound. In the same language, different graphical sign/representation depicting a particular letter term, are phonologically uttered with the same sound(s) (like “a” and “A”).

An “attribute” of a term (alphanumeric symbol, letter, or number) is defined as a spatial distinctive related perceptual feature and/or time distinctive related perceptual feature. An attribute of a term can also be understood as a related on-line perceptual representation carried through a mental simulation that effects the off-line conception of what it's been perceived. (Louise Connell, Dermot Lynott. Principles of Representation: Why You Can't Represent the Same Concept Twice. Topics in Cognitive Science (2014) 1-17)

A “spatial related perceptual attribute” is defined as a characteristically spatial related perceptual feature of a term, which can be discriminated by sensorial perception. There are two kinds of spatial related perceptual attributes.

An “individual spatial related attribute” is defined as a spatial related perceptual attribute that pertains to a particular term. Individual spatial related perceptual attributes include, e.g., symbol case; symbol size; symbol font; symbol boldness; symbol tilted angle in relation to a horizontal line; symbol vertical line of symmetry; symbol horizontal line of symmetry; symbol vertical and horizontal lines of symmetry; symbol infinite lines of symmetry; symbol no line of symmetry; and symbol reflection (mirror) symmetry.

A “collective spatial related attribute” is defined as a spatial related perceptual attribute that pertains to the relative location of a particular term in relation to the other terms in a letter set array, an alphabetic set array, or an alphabetic letter symbol sequence. Collective spatial related attributes (e.g. in a set array) include a symbol ordinal position, the physical space occupied by a symbol font, the distance between the physical spaces occupied by the fonts of two consecutive symbols/terms when represented in orthographical form, and left or right relative edge position of a term/symbol font in a set array. Even if triggering a sensorial perceptual relation with the reasoning subject, a “collective spatial related perceptual attribute” is not related to the semantic meaning of the one or more letter symbols possessing this spatial perceptual related attribute. In contrast, the “collective critical space” is contingent on the generation of a semantic meaning in a subject by the pair of non-contiguous letter symbols implicitly entailing this collective critical space.

A “time related perceptual attribute” is defined as a characteristically temporal related perceptual feature of a term (symbol, letter or number), which can be discriminated by sensorial perception such as: a) any color of the RGB full color range of the symbols term; b) frequency range for the intermittent display of a symbol, of a letter or of a number, from a very low frequency rate, up till a high frequency (flickering) rate. Frequency is quantified as: 1/t, where t is in the order of seconds of time; c) particular sound frequencies by which a letter or a number is recognized by the auditory perception of a subject; and d) any herein particular constant motion represented by a constant velocity/constant speed (V) at which symbols, letters, and/or numbers move across the visual or auditory field of a subject. In the case of Doppler auditory field effect, where sounds representing the names of alphanumeric symbols, letters, and/or numbers are approximating or moving away in relation to a predefined point in the perceptual space of a subject, constant motion is herein represented by the speed of sound. By default, this constant motion of symbols, letters, and/or numbers is herein considered to take place along a horizontal axis, in a spatial direction to be predefined. If the visual perception of constant motion is implemented on a computer screen, the value of V to be assigned is given in pixels per second at a predefined screen resolution.

It has been empirically observed that when the first and last letter symbols of a word are maintained, the reader's semantic meaning of the word may not be altered or lost by removing one or more letters in between them. This orthographic transformation is named data “compression”. Consistent with this empirical observation, the notion of data “compression” is herein extended into the following definitions:

If a “symbols sequence is subject to compression” which is characterized by the removal of one or more contiguous symbols located in between two predefined symbols in the sequence of symbols, the two predefined symbols may, at the end of the compression process, become contiguous symbols in the symbols sequence, or remain non-contiguous if the omission or removal of symbols is done on non-contiguous symbols located between the two predefined symbols in the sequence.

Due to the intrinsic semantic meaning carried by an open proto-bigram term, when the two predefined symbols in a sequence of symbols are the two letters symbols forming an open proto-bigram term, the compression of a letter sequence is considered to take place at two sequential levels, “local” and “non-local”, and the non-local sequential level comprises an “extraordinary sequential compression case.”

A “local open proto-bigram term compression” is characterized by the omission or removal of one or two contiguous letters in a sequence of letters lying in between the two letters that form/assemble an open proto-bigram term, by which the two letters of the open proto-bigram term become contiguous letters in the letters sequence.

A “non-local open proto-bigram compression” is characterized by the omission or removal of more than two contiguous letters in a sequence of letters, lying in between two letters at any ordinal serial position in the sequence that form an open proto-bigram term, by which the two letters of the open proto-bigram term become contiguous letters in the letters sequence.

An “extraordinary non-local open proto-bigram compression” is a particular case of a non-local open proto-bigram term compression, which occurs in a letters sequence comprising N letters when the first and last letters in the letters sequence are the two selected letters forming/assembling an open proto-bigram term, and the N-2 letters lying in between are omitted or removed, by which the remaining two letters forming/assembling the open proto-bigram term become contiguous letters.

An “alphabetic expansion” of an open proto-bigram term is defined as the orthographic separation of its two (alphabetical non-contiguous letters) letters by the serial sensory motor insertion of the corresponding incomplete alphabetic sequence directly related to its collective critical space according to predefined timings. This sensory motor ‘alphabetic expansion’ will explicitly make the particular related virtual sequential state entailed in the collective critical space of this open proto-bigram term concrete.

“Orthographic letters contiguity” is defined as the contiguity of letters symbols in a written form by which words are represented in most written alphabetical languages.

For “alphabetic contiguity,” a visual recognition facilitation effect occurs for a pair of letters forming any open bigram term, even when 1 or 2 letters in orthographic contiguity lying in between these two (now) edge letters form the open bigram term. It has been empirically confirmed that up to 2 letters located contiguously in between the open bigram term do not interfere with the visual identity and resulting perceptual recognition process of the pair of letters making-up the open bigram term. In other words, the visual perceptual identity of an open bigram term (letter pair) remains intact even in the case of up two letters held in between these two edge letters forming the open bigram term.

However, in the particular case where open bigram terms orthographically directly convey/communicate a semantic meaning in a language (e.g., open proto-bigrams), it is herein considered that the visual perceptual identity of open proto-bigram terms remains intact even when more than 2 letters are held in between the now edge letters forming the open proto-bigram term. This particular visual perceptual recognition effect is considered as an expression of: 1) a Local Alphabetic Contiguity effect—empirically manifested when up to two letters are held in between (LAC) for open bigrams and open proto-bigrams terms and 2) a Non-Local Alphabetic Contiguity (NLAC) effect—empirically manifested when more than two letters are held in between, an effect which only take place in open proto-bigrams terms.

Both LAC and NLAC are part of a herein novel methodology aiming to advance a flexible orthographic decoding and processing view concerning sensory motor grounding of perceptual-cognitive alphabetical, numerical, and alphanumeric information/knowledge. LAC correlates to the already known priming transposition of letters phenomena, and NLAC is a new proposition concerning the visual perceptual recognition property particularly possessed only by open proto-bigrams terms which is enhanced by the performance of the herein proposed methods. For the 24 open proto-bigram terms found in the English language alphabet, 7 open proto-bigram terms are of a default LAC consisting of 0 to 2 in between ordinal positions of letters in the alphabetic direct-inverse set array because of their unique respective intrinsic serial order position in the alphabet. The remaining 17 open proto-bigrams terms are of a default NLAC consisting of an average of more than 10 letters held in between ordinal positions in the alphabetic direct-inverse set array.

The present subject matter considers the phenomena of ‘alphabetic contiguity’ being a particular top-down cognitive-perceptual mechanism that effortlessly and autonomously causes arousal inhibition in the visual perception process for detecting, processing, and encoding the N letters held in between the 2 edge letters forming an open proto-bigram term, thus resulting in maximal data compression of the letters sequence. As a consequence of the alphabetic contiguity orthographic phenomena, the space held in between any 2 non-contiguous letters forming an open proto-bigram term in the alphabet is of a critical perceptual related nature, herein designated as a ‘Collective Critical Space Perceptual Related Attribute’ (CCSPRA) of the open proto-bigram term, wherein the letters sequence which is attentionally ignored-inhibited, should be conceptualized as if existing in a virtual mental kind of state. This virtual mental kind of state will remain effective even if the 2 letters making-up the open proto-bigram term will be in orthographic contiguity (maximal serial data compression).

When the 2 letters forming an open proto-bigram term hold in between a number of N letters and when the serial ordinal position of these two letters are the serial position of the edge letters of a letters sequence (meaning that there are no additional letters on either side of these two edge letters), the alphabetic contiguity property will only pertain to these 2 edge letters forming the open proto-bigram term. In brief, this particular case discloses the strongest manifestation of the alphabetic contiguity property, where one of the letters making up an open proto-bigram term is the head and the other letter is the tail of a letters sequence. This particular case is herein designated as Extraordinary NLAC.

An “arrangement of terms” (symbols, letters and/or numbers) is defined as one of two classes of term arrangements, i.e., an arrangement of terms along a line, or an arrangement of terms in a matrix form. In an “arrangement along a line,” terms will be arranged along a horizontal line by default. If for example, the arrangement of terms is meant to be along a vertical or diagonal or curvilinear line, it will be indicated. In an “arrangement in a matrix form,” terms are arranged along a number of parallel horizontal lines (like letters arrangement in a text book format), displayed in a two dimensional format.

The terms “generation of terms,” “number of terms generated” (symbols, letters and/or numbers) is defined as terms generally generated by two kinds of term generation methods—one method wherein the number of terms is generated in a predefined quantity; and another method wherein the number of terms is generated by a quasi-random method.

The subject matter is generally related to promoting reasoning abilities in a subject through the use and manipulation of open-bigrams and/or open proto-bigrams. To be more specific and as provided in the Example below, the method of promoting pattern recognition and sensory motor selection of open-bigram terms in a subject comprises selecting a first predefined number of open-bigram terms and a second predefined number of open-bigram terms from any class all having the same spatial and time perceptual related attributes from a library of open-bigram terms of a selected language, arranging the second predefined number of open-bigram terms in a number of arrays distributed in a predefined matrix, selecting one or more sectors of the matrix wherein the selected first predefined number of open-bigram terms will replace an equal number of the selected second predefined number of open-bigram terms, and providing the arranged matrix of open-bigrams terms to the subject with a ruler displaying open-bigram terms from the selected language wherein the first predefined number of open-bigram terms are target terms and the second predefined number of open-bigram terms are distractor terms. The subject is then prompted to search, recognize, and select all of the target terms in the arranged matrix within a first predefined time period.

If the subject made a correct selection, then the correctly selected target term is displayed with at least one different spatial or time perceptual related attribute in the arranged matrix and the ruler. However, if the selection made by the subject is incorrect, the subject is returned to the prior step of being prompted to search, recognize, and select all of the target terms in the arranged matrix within a first predefined time period. If the subject has correctly selected all of the target terms in the arranged matrix, then the correctly selected target terms are again displayed with at least one different spatial or time perceptual related attribute in the arranged matrix and the ruler when the last target term is selected.

The above steps in the method are repeated for a predetermined number of iterations separated by second predefined time intervals, and upon completion of the predetermined number of iterations, the subject is provided with the results of each iteration. The predetermined number of iterations can be any number needed to establish that a proficient reasoning performance concerning the particular task at hand is being promoted within the subject. Non-limiting examples of number of iterations include 1, 2, 3, 4, 5, 6, and 7.

It is important to point out/consider that, in the above method of promoting reasoning abilities and in the following exercises and examples implementing the method, the subject is performing the discrimination of open bigrams or open proto-bigram terms in an array/series of open bigrams and/or open proto-bigram sequences without invoking explicit conscious awareness concerning underlying implicit governing rules or abstract concepts/interrelationships, characterized by relations or correlations or cross-correlations among the searched, discriminated and sensory motor manipulated open bigrams and open proto-bigrams terms by the subject. In other words, the subject is performing the search and discrimination without overtly thinking or strategizing about the necessary actions to effectively accomplish the sensory motor manipulation of the open bigrams and open proto-bigram terms.

As mentioned in connection with the general form of the above definitions, the herein presented suite of exercises can make use of not only letters but also numbers and alphanumeric symbols relationships. These relationships include correlations and cross-correlations among open bigrams and/or open proto-bigram terms such that the mental ability of the exercising subject is able to promote novel reasoning strategies that improve fluid intelligence abilities. The improved fluid intelligence abilities will be manifested in at least effective and rapid mental simulation, novel problem solving, drawing inductive-deductive inferences, pattern and irregularities recognition, identifying relations, correlations and cross-correlations among sequential orders of symbols comprehending implications, extrapolating, transforming information and abstract concept thinking.

As mentioned earlier, it is also important to consider that the methods described herein are not limited to only alphabetic symbols. It is also contemplated that the methods of the present subject can involve numeric serial orders and/or alpha-numeric serial orders to be used within the exercises. In other words, while the specific examples set forth employ serial orders of letter symbols, alphabetic open bigram terms and alphabetic open proto-bigram terms, it is contemplated that serial orders comprising numbers and/or alpha-numeric symbols can be used.

The library of complete open proto-bigram sequences comprises a predefined number of set arrays (closed serial orders of terms: alphanumeric symbols/letters/numbers), which may include alphabetic set arrays. Alphabetic set arrays are characterized by a predefined number of different letter terms, each letter term having a predefined unique ordinal position in the closed set array, and none of said different letter terms are repeated within this predefined unique serial order of letter terms. A non-limiting example of a unique set array is the English alphabet, in which there are 13 predefined different open-bigram terms where each open-bigram term has a predefined consecutive ordinal position of a unique closed serial order among 13 different members of a set array only comprising 13 open-bigram term members.

In one aspect of the present subject matter, a predefined library of complete open-bigrams sequences is considered, which may comprise set arrays. A unique serial order of open-bigram terms can be obtained from the English alphabet, as one among the at least six other different unique serial orders of open-bigram terms. In particular, an alphabetic set array can be obtained from the English alphabet, which is herein denominated: direct alphabetic open-bigram set array. The other five different orders of the same open-bigram terms are also unique alphabetic open-bigram set arrays, which are herein denominated: inverse alphabetic open-bigram set array, direct type of alphabetic open-bigram set array, inverse type of alphabetic open-bigram set array, central type of alphabetic open-bigram set array, and inverse central type alphabetic open-bigram set array. It is understood that the above predefined library of open-bigram terms sequences may contain fewer open-bigram terms sequences than those listed above or may comprise more different open-bigram set arrays.

In an aspect of the present methods, the at least one unique serial order comprises a sequence of open-bigram terms. In this aspect, the predefined library of set arrays may comprise the following set arrays of sequential orders of open-bigrams terms, where each open-bigram term is a different member of the set array having a predefined unique ordinal position within the set: direct open-bigram set array, inverse open-bigram set array, direct type open-bigram set array, inverse type open-bigram set array, central type open-bigram set array, and inverse central type open-bigram set array. It is understood that the above predefined library of set arrays may contain additional or fewer set arrays sequences than those listed above.

In a further aspect of the present methods, the subject is required to sensory-motor select target terms from a provided open-bigram terms matrix. For all of the exercises discussed herein, the subject may execute the sensory-motor selection by performing one or more sensory activities. Without restriction, the one or more sensory activities may include touching the screen of the display where the target term(s) are located, clicking on the selected target term with a mouse, voicing the sounds the selected target terms represent, and touching each selected target term from the arranged matrix with a pointer or stick.

### Example 1

### Pre-Attentive Parallel Visual Search, Pattern Recognition, and Sensory Motor Selection of One or More Target Terms within a Crowd of Distractor Terms in an Open-Bigrams Matrix

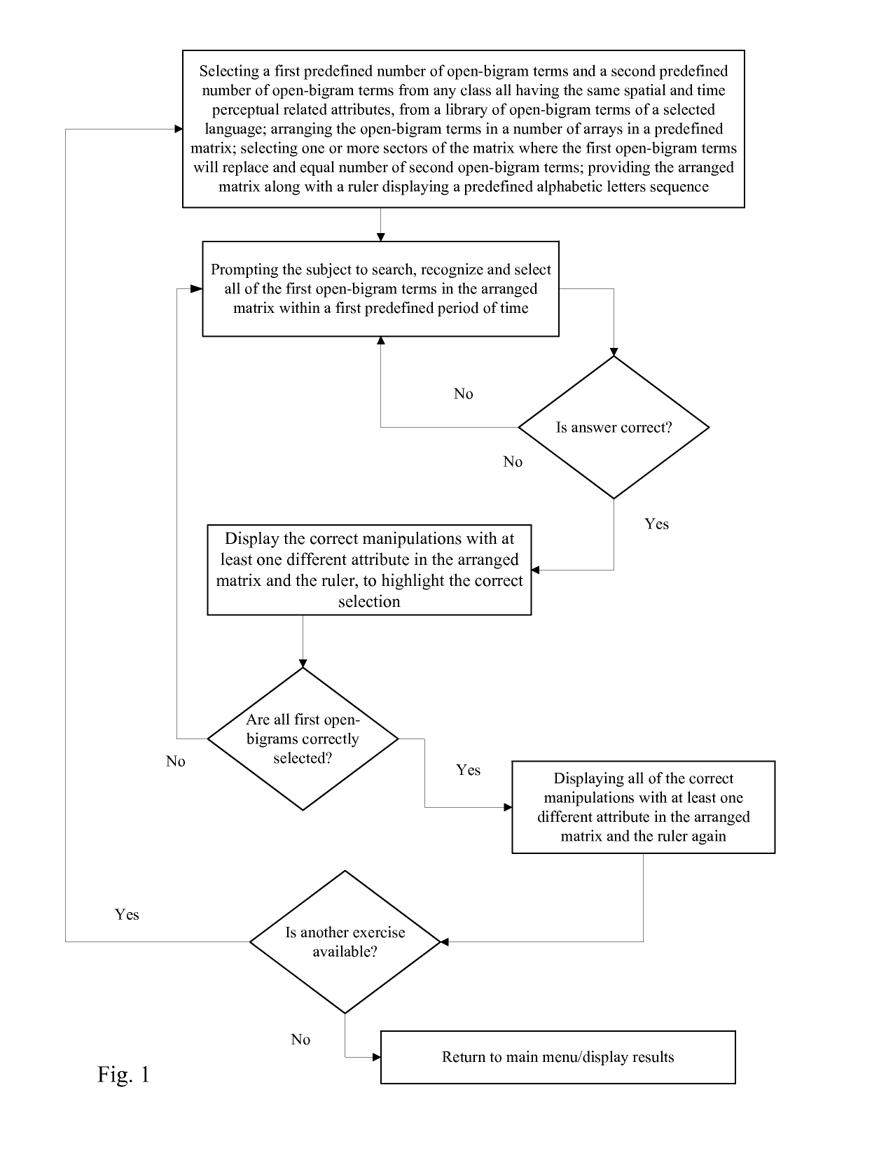

A goal of the presented Example 1 is to promote a subject's ability to visually search, perform an efficient and fast pattern recognition and sensory motor selection of one or more target terms embedded in a crowd of distractor terms in a provided open-bigrams matrix. FIG. 1 is a flow chart setting forth the broad concepts of method that the present exercises use in promoting fluid intelligence abilities in a subject by promoting pattern recognition and sensory motor selection of target terms.

As can be seen in FIG. 1, the method of promoting pattern recognition and sensory motor selection of open-bigram terms in a subject comprises selecting a first number of open-bigram terms and a second number of open-bigram terms of any class from a library of open-bigram terms of a selected language, arranging the second number of open-bigram terms in a number of arrays in a predefined matrix, and selecting one or more sectors in the matrix where the selected first number of open-bigram terms replace an equal number of the selected second number of open-bigram terms, wherein the first number of open-bigram terms are target terms and the second number of open-bigram terms are distractor terms. All of the open-bigram terms have the same spatial and time perceptual related attributes. In addition to the arranged open-bigrams matrix, the subject is also provided with a ruler displaying an alphabetic letters sequence from the selected language. The subject is then prompted to search, recognize, and select all of the target terms in the arranged open-bigrams matrix within a first predefined time period. Correctly selected target terms are displayed with at least one different spatial or time perceptual related attribute in the arranged open-bigrams matrix and the ruler. However, if the selection made by the subject is incorrect, then the subject is returned to the prior step of being prompted to search, recognize, and select all of the target terms in the arranged open-bigrams matrix. When the last correct target term is selected from the open-bigrams matrix, all of the correctly selected target terms are again displayed with at least one different spatial or time perceptual related attribute in the arranged open-bigrams matrix and the ruler.

The above steps in the method are repeated for a predetermined number of iterations separated by second predefined time intervals, and upon completion of the predetermined number of iterations, the subject is provided with the results of each iteration. The predetermined number of iterations can be any number needed to establish that a proficient reasoning performance concerning the particular task at hand is being promoted within the subject. Non-limiting examples of number of iterations include 1, 2, 3, 4, 5, 6, and 7.

In another aspect of Example 1, the method of promoting pattern recognition and sensory motor selection of open-bigram terms in a subject is implemented through a computer program product. Particularly, the subject matter in Example 1 includes a computer program product for promoting pattern recognition and sensory motor selection of open-bigram terms in a subject, stored on a non-transitory computer-readable medium which when executed causes a computer system to perform a method. The method executed by the computer program on the non-transitory computer readable medium comprises selecting a first number of open-bigram terms and a second number of open-bigram terms of any class from a library of open-bigram terms of a selected language, arranging the second number of open-bigram terms in a number of arrays in a predefined open-bigrams matrix, and selecting one or more sectors in the open-bigrams matrix where the selected first number of open-bigram terms replace an equal number of the second number of open-bigram terms, wherein the first number of open-bigram terms are target terms and the second number of open-bigram terms are distractor terms. All of the open-bigram terms have the same spatial and time perceptual related attributes. In addition to the arranged open-bigrams matrix, the subject is also provided with a ruler displaying a predefined alphabetic letters sequence from the selected language. The subject is then prompted to search, recognize, and sensory motor select all of the target terms in the arranged open-bigrams matrix within a first predefined time period. Correctly selected target terms are displayed with at least one different spatial or time perceptual related attribute in the arranged open-bigrams matrix and the ruler. However, if the selection made by the subject is incorrect, then the subject is returned to the prior step of being prompted to search, recognize, and sensory motor select all of the target terms in the arranged open-bigrams matrix. When the last correct target term is selected from the open-bigrams matrix, all of the correctly selected target terms are again displayed with at least one different spatial or time perceptual related attribute in the arranged open-bigrams matrix and the ruler.

The above steps in the method are repeated for a predetermined number of iterations separated by one or more predefined time intervals, and upon completion of the predetermined number of iterations, the subject is provided with the results of each iteration.

In a further aspect of Example 1, the method of promoting pattern recognition and sensory motor selection of open-bigram terms in a subject is implemented through a system. The system for promoting pattern recognition and sensory motor selection of open-bigram terms in a subject comprises: a computer system comprising a processor, memory, and a graphical user interface (GUI), the processor containing instructions for: selecting a first number of open-bigram terms and a second number of open-bigram terms from a library of open-bigram terms of a selected language, arranging the second number of open-bigram terms in a number of arrays in a predefined open-bigrams matrix, and selecting one or more sectors in the open-bigrams matrix where the selected first number of open-bigram terms replace an equal number of the second number of open-bigram terms, wherein the first number of open-bigram terms are target terms and the second number of open-bigram terms are distractor terms, and wherein all of the open-bigram terms have the same spatial and time perceptual related attributes, and providing the arranged open-bigrams matrix and a ruler displaying a predefined alphabetic letters sequence from the selected language to the subject on the GUI; prompting the subject on the GUI to search, recognize, and sensory motor select all of the target terms in the arranged open-bigrams matrix within a first predefined time period; determining if the subject correctly selected a target term; if the selection made by the subject is a correct selection, then displaying the correctly selected target term on the GUI with a different spatial or time perceptual related attribute in the arranged open-bigrams matrix and the ruler; if the selection made by the subject is incorrect, then returning to the step of prompting the subject to search, recognize, and sensory motor select all of the target terms in the arranged open-bigrams matrix; if the selection made by the subject is of the last correct target term from the arranged open-bigrams matrix, then again displaying all of the correctly selected target terms on the GUI with at least one different spatial or time perceptual related attribute in the arranged open-bigrams matrix and the ruler; repeating the above steps for a predefined number of iterations separated by one or more predefined time intervals; and upon completion of a predefined number of iterations, providing the subject with the results of all of the iterations.

In the present example, the subject is required to exercise on the fly, an efficient visual search and fast pattern recognition and sensory motor selection of one or more target terms while inhibiting his/her visual attention and perceptual orienting from focusing on a crowd of open-bigrams or open proto-bigrams distractor terms. It is contemplated that the selected target terms may be open-bigram terms or open proto-bigram terms, and likewise, the selected distractor terms may be either open-bigram or open proto-bigram terms. In general, this task is accomplished by a predetermined configuration of open-bigram or open proto-bigram distractor terms that automatically steer the subject's pre-attentive visual spatial attention to effortlessly conduct an efficient pre-attentive visual search. The uniqueness of the herein visual search is manifested by the visual attention mechanism committed in parallel to fast and efficient recognition of salient spatial or time perceptual related attributes possessed by one or more target terms which differ in kind from those spatial or time perceptual related attributes possessed by the crowd of open-bigram or open proto-bigram distractor terms in the arranged open-bigrams matrix. Particularly, the target terms are embedded within a crowd of open-bigram or open proto-bigram distractor terms arranged in a predefined open-bigrams matrix format.

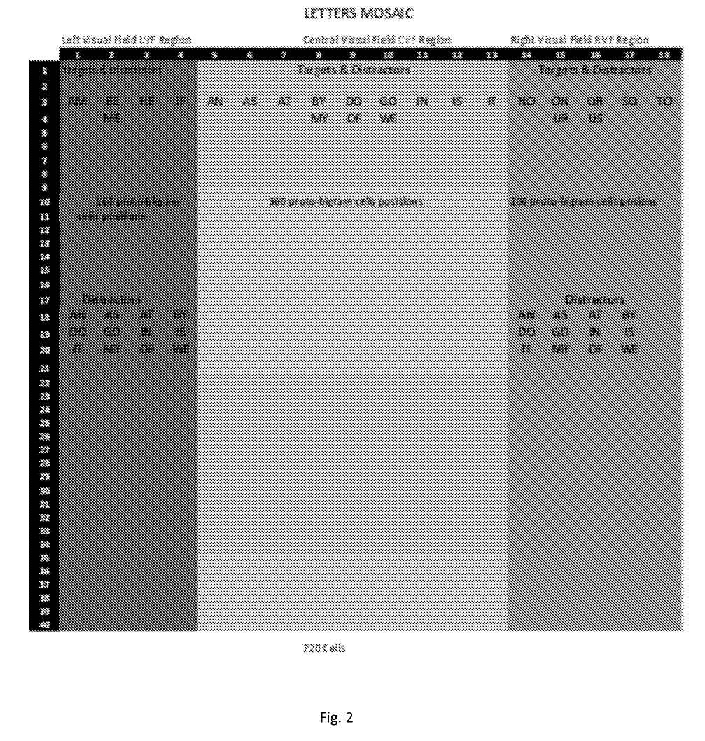

In a non-limiting aspect of the present Example, the spatial structure concerning the distribution of the herein presented open proto-bigrams target(s) and distractors terms comprise an “open proto-bigrams terms matrix”. The open proto-bigrams terms matrix is composed of open proto-bigrams terms displayed serially, forming open proto-bigrams terms sequences which may include arrays of the same open proto-bigram term. In the present example, all open proto-bigrams terms are serially joined together horizontally to form open proto-bigrams terms sequences of the same terms. When these open proto-bigrams sequences are stacked vertically, they depict an open proto-bigrams terms matrix. In essence, an open proto-bigrams terms matrix includes a kind of “pair of symbols matrix” that displays two kinds of open proto-bigrams terms in a sequential manner. The first kind of open proto-bigram terms is herein denominated open proto-bigrams “targets” and the second kind of open proto-bigrams terms is herein denominated open proto-bigrams “distractors.” FIG. 2 shows non-limiting exemplary possible open proto-bigrams matrix configurations.

In another non-limiting aspect of the present Example, the open proto-bigrams terms matrix may also be composed of open-bigrams which are not of the open proto-bigrams class. In other words, it is contemplated that the open proto-bigrams terms matrix can also be considered as an open-bigram terms matrix in which open-bigram terms make up the bulk of the matrix, and wherein open proto-bigrams to be searched and identified as target terms will replace an equal number of open-bigram terms within the matrix. In this aspect, it is understood that whenever the open proto-bigrams terms matrix is described above and below, the description applies equally to a non-proto-bigram terms matrix that may consist mainly of open-bigram terms.

In an embodiment of the present Example, the open-bigram terms are selected from a library of English language open-bigram terms. Further, any class of open-bigram terms may comprise three open-bigram terms classes including: 1) open proto-bigram terms; 2) alphabetic open-bigram set arrays; and 3) all open-bigram terms of non-repeated letters not of classes 1) or 2). Still, the alphabetic open-bigram set arrays may include: direct open-bigram set arrays, inverse open-bigram set arrays, direct type open-bigram set arrays, inverse type open-bigram set arrays, central type open-bigram set arrays, and inverse central type open-bigram set arrays.

In a non-limiting example, each open proto-bigrams terms matrix comprises 1440 single letter symbols or 720 open proto-bigram terms namely, target(s) and distractors open proto-bigrams terms. These 720 open proto-bigram targets and distractors terms are spatially horizontally distributed inside the open proto-bigram terms matrix forming open proto-bigrams terms sequences in a selected number of horizontal arrays. In one embodiment, the number of horizontal arrays is between 30 and 50. More so, each open proto-bigrams terms sequence entails 18 open proto-bigrams terms in the array (making-up an open proto-bigrams sequence of 36 single letters symbols). Yet, each horizontal array of open proto-bigrams terms sequence is configured such that 40 other same terms length open proto-bigrams sequences are stacked upon each other vertically, thus generating a 720 open proto-bigrams terms matrix over a spatial surface. It is also contemplated that the predefined matrix format may be configured such that the left and right borders of the predefined matrix format do not line up to form a straight vertical line in accordance with a predefined number of horizontal arrays with different numbers of open proto-bigram terms.

Open-bigram terms may be arranged in the open-bigram terms matrix by a previously selected direct alphabetic or inverse alphabetic serial order. Alternatively, the open-bigram terms may be arranged in the open-bigram terms matrix at random. In some embodiments, the selected number of open proto-bigram target terms may range from 1 to 9 terms while the combined number of target terms and distractor terms may range from 360 to 1200 terms for a given arranged open-bigram terms matrix. Further still, the total number of open-bigram and open proto-bigram terms in each horizontal array of the arranged matrix may be between 12 and 24.

In a non-limiting example, the open proto-bigrams terms matrix spatial coordinates are divided into 3 distinctive visual fields regions. Accordingly, the spatial coordinates of each open proto-bigram target and distractor term inside the open proto-bigrams terms matrix are derived and correlated to the specific visual field region serially occupied by each of the single letters forming an alphabetical serial order sequence (e.g., the English alphabet). The present example presents the selected open proto-bigram targets (from the 24 English language open proto-bigrams terms) as located inside the open proto-bigrams terms matrix in direct correlation to their respective visual field region affiliation in the alphabetical serial order sequence of relevance (e.g., English language) in the following manner: the Left Visual Field (LVF) region contains the left group open proto-bigrams terms: AM, BE, IF, HE and ME; the Central Visual Field (CVF) region contains the central group open proto-bigrams terms: IN, GO, OF, IS, DO, IT, MY, AN, AS, WE, AT, and BY; and the Right Visual Field (RVF) region contains the right group open proto-bigrams terms: NO, ON, US, OR, SO, TO and UP. The LVF region, CVF region, and RVF region may also be interchangeably referred to as the left sector, the central sector, and the right sector, respectively, of the predefined open proto-bigram terms matrix.

Still, within the open proto-bigrams terms matrix, each visual field region comprises a different number of cells, wherein each open proto-bigram term or each open-bigram is considered as a “cell.” In the following non-limiting example, an open proto-bigram terms matrix having three visual field regions is made up of 40 horizontal rows, one row above another in a vertical arrangement, and with each row comprising 18 open proto-bigram terms. The LVF region extends horizontally and vertically, starting from the first upper left inside open proto-bigram terms sequence horizontally until cell position #4, and vertically until cell position #40 thus occupying a total surface made of 4×40=160 cell positions constituting the left sector. Selected LVF open proto-bigrams target(s) terms options will be exclusively displayed within these 160 cells positions of the left sector inside the open proto-bigrams terms matrix. Left group open proto-bigram terms will also be displayed on a left side of the ruler for the subject's reference in some embodiments. Selected LVF open proto-bigrams terms options are herein operationally predefined to be treated as ‘targets’ or ‘distractor’ terms. However, RVF open proto-bigrams terms cannot be selected to be open proto-bigrams terms distractors to any selected open proto-bigrams target(s) in the LVF region.

In the same non-limiting example, CVF open proto-bigram terms options will be displayed in the CVF region, which extends horizontally and vertically, starting from the upper left horizontal open proto-bigram terms sequence that is horizontal from cell position #5 to cell position #13 and vertical until cell position #40, occupying a total surface of 9×40=360 cell positions constituting the central sector of the open proto-bigrams terms matrix. Central group open proto-bigram terms will also be displayed in a central part of the ruler for the subject's reference in some embodiments. All CVF region open proto-bigrams terms are herein operationally predefined to be treated as ‘targets’ and ‘distractor’ open proto-bigrams terms. CVF region open proto-bigrams terms may also be open proto-bigrams distractor terms to open proto-bigrams target(s) terms selected from the LVF and RVF regions. However, LVF and RVF open proto-bigrams terms cannot be distractors terms to any open proto-bigrams target(s) terms selected from the CVF region. Further, when a particular CVF open proto-bigram term option is selected to be an open proto-bigram ‘target’ term, this option will be displayed exclusively in the particular assigned 360 cells within the CVF region inside the open proto-bigrams terms matrix.

In still the same non-limiting example, the RVF region extends horizontally and vertically, starting from the upper most left open proto-bigrams terms sequence, horizontal from cell position #14 to cell position #18 and vertical until cell position #40, occupying a total surface of 5×40=200 cell positions constituting the right sector of the open proto-bigrams terms matrix. Right group open proto-bigram terms will also be displayed on a right side of the ruler for the subject's reference in some embodiments. Selected RVF open proto-bigrams terms are herein operationally predefined to be treated as ‘targets’ or ‘distractors.’ Nevertheless, LVF region open proto-bigrams terms cannot be selected to be open proto-bigrams distractor terms to any selected open proto-bigram target(s) terms in the RVF region. Further, the selected RVF open proto-bigrams target(s) terms option will be displayed exclusively within the 200 cells positions assigned to the RVF region inside the open proto-bigrams terms matrix.

Given that the predefined open proto-bigram terms matrix is only made up of “cells” of targets and distractors, the following open proto-bigrams proportions are defined as a default arrangement of the open proto-bigram terms matrix in some embodiments. The left sector has the closest integer number to 20% of all of the “cells” in the open proto-bigram terms matrix, the central sector has the closest integer number to 50% of all of the “cells”, and the right sector has the closest integer number to 30% of all of the “cells”. However, other percentage distributions by sector of open proto-bigram terms for an arranged open proto-bigram matrix are also contemplated. In other words, the predefined open proto-bigram terms matrix may be arranged with any other predefined open proto-bigram terms proportion of the selected open proto-bigram terms between the left, central, and right sectors.

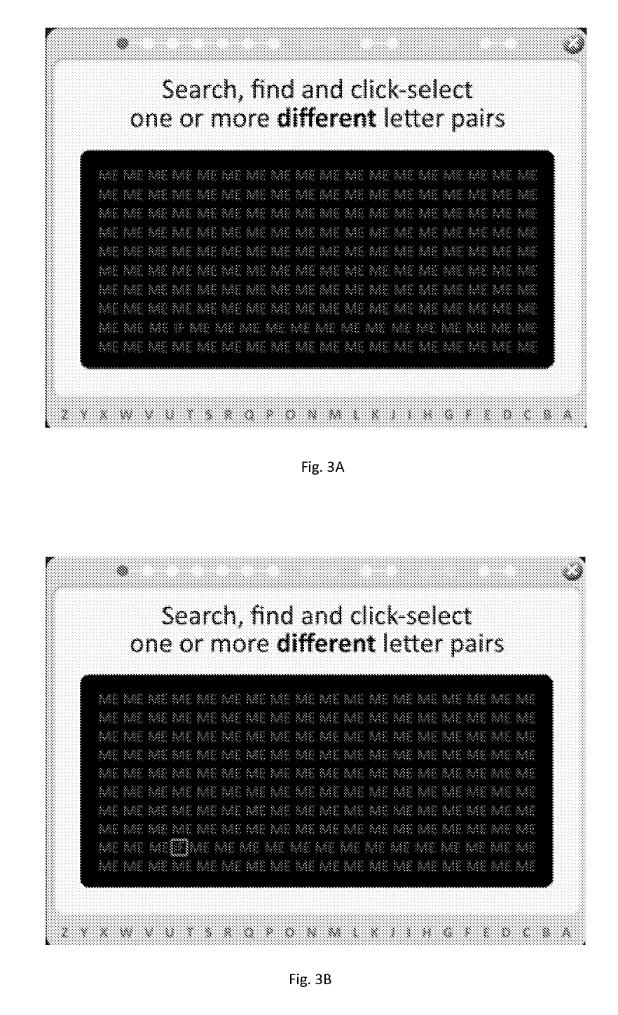

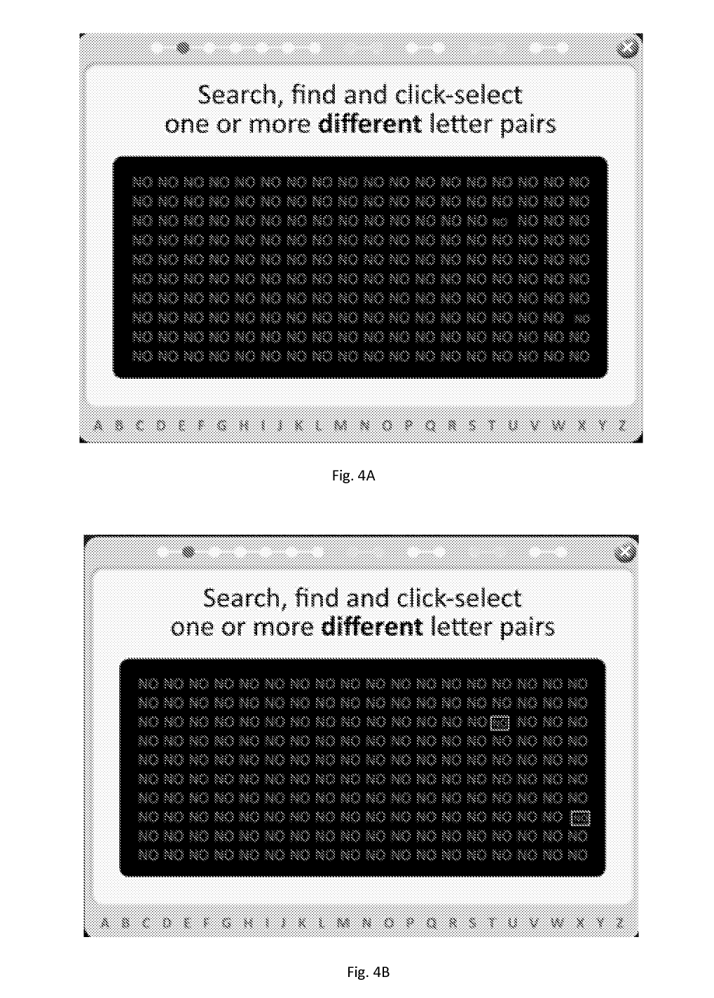

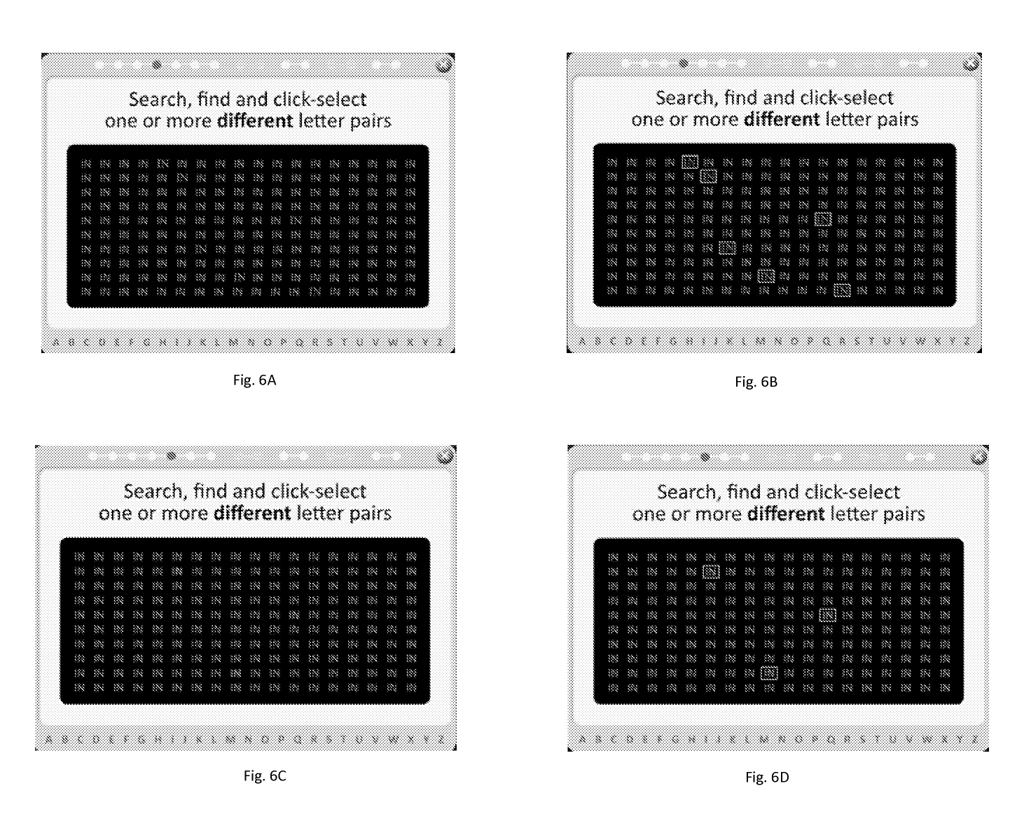

In another aspect of the present example, different time perceptual related attribute colors may be assigned to open proto-bigrams terms options in correlation to their specific target operational roles inside the open proto-bigrams terms matrix. In a non-limiting example, an open proto-bigram target-distractor pair of terms from the same spatial visual field region will be displayed in a first time perceptual related attribute color inside the open proto-bigrams terms matrix. As shown in FIG. 3A, in the LVF region, the open proto-bigram target term “IF” and the open proto-bigram distractor term “ME” are both displayed in the time perceptual related attribute red color inside the open proto-bigram terms matrix. Yet, when open proto-bigrams targets terms options are to be displayed inside a second spatial visual field region inside the open proto-bigrams terms matrix, open proto-bigrams target(s) and distractors terms will be displayed in a second time perceptual related attribute color. As shown in FIG. 6A, in the CVF region, the open proto-bigram target(s) and distractor terms are both displayed in the time perceptual related attribute green color. Still, when one or more selected open proto-bigrams targets terms options are to be displayed inside a third spatial visual field region inside the open proto-bigrams terms matrix, open proto-bigram target(s) and distractors terms will be displayed in a third time perceptual related attribute color. As shown in FIG. 4A, in the RVF region, the open proto-bigram target(s) and distractor terms are displayed in the time perceptual related attribute blue color.

For the particular case where the time perceptual related attribute velocity V is selected for any open proto-bigrams target(s) terms at any visual field region inside the open proto-bigrams terms matrix for any open proto-bigrams terms matrix trial exercise of the present task, the initial assigned time perceptual related attribute color of the selected open proto-bigram target(s) term(s) will remain active until the completion of the trial exercise, regardless of the selected open proto-bigrams target(s) terms potential to move across multiple visual field regions inside the open proto-bigrams terms matrix.

In a general aspect of the present example, for each block exercise and in each trial exercise, the type and amount of open proto-bigram and/or open-bigram terms will be selected in a randomly or pre-assigned manner from a library featuring different open proto-bigrams and open-bigram choices. Particularly, the open proto-bigrams or the open-bigram terms matrix may be configured based on at least the following options: 1) a single open-bigram or open proto-bigram term that will play a dual operational role, as the target term(s) and the distractor terms, inside the matrix; and 2) two distinct open-bigram or open proto-bigram terms, where one term is selected to be the target(s) and a second different term choice is selected to be the distractor terms. Alternatively, it is contemplated that the subset of open-bigram terms (distractor terms) selected to be replaced by the target open proto-bigram terms are not replaced and instead become target terms in the arranged open bigram term matrix.

The target terms and all of the distractor terms may be perceptually differentiated at the outset of an exercise for an arranged open bigram or open proto-bigram terms matrix by having preselected different spatial and/or time perceptual related attributes. It is further noted that the visual spatial field regions may impact the number of open proto-bigram target(s) terms options displayed therein. Particularly, only a single (1) open proto-bigram target term is allowed to be displayed for the LVF region, no more than two (2) open proto-bigram target terms can be displayed for the RVF region, and no fewer than three (3) but no more than six (6) open proto-bigrams target terms are allowed to be displayed for the CVF region.

In a further aspect of the present example, certain spatial and time perceptual related attributes may be changed for the open proto-bigram terms. In general, open proto-bigram target(s) and distractor terms are visually perceptually distinct by a single salient spatial or time perceptual related attribute. However, in some embodiments, all of the open proto-bigram target(s) and all of the open proto-bigrams distractor terms are almost visually perceptually alike/the same. In a non-limiting example, all of the open proto-bigrams distractors terms are displayed inside the open proto-bigrams terms matrix with a first spatial perceptual related attribute font while the open proto-bigrams target(s) terms are displayed with a second spatial perceptual related attribute font. Otherwise, all of the other spatial and time perceptual related attributes of the open proto-bigrams target(s) and distractors terms are strictly displayed as the same. Thus, this single pre-assigned salient spatial or time perceptual related attribute difference between open proto-bigram target(s) and distractor terms should be effortlessly and rapidly picked-up by the subject's peripheral attentional system, such that it is expected that the subject's brain will successfully inhibit focusing his/her attention to the crowd of open proto-bigrams distractor terms. Further, it is also expected that the user will immediately recognize (isolate from the open proto-bigrams distractors crowd) the open proto-bigrams target(s) terms and immediately proceed to correctly sensory motor select the target(t) terms according to the specific requirements of the given exercise.

Additionally, the open proto-bigrams target(s) and/or distractor terms inside the open proto-bigrams terms matrix may have the following spatial or spatial collective or time perceptual related attributes changes: A) different open proto-bigrams target(s) and distractors terms configurations—distinctive open proto-bigram target-distractor terms derive from different ordinal positions occupied by these open proto-bigrams terms in a pre-assigned open proto-bigrams direct or inverse sequence (from a library of open-bigrams sequences); B) font size change; C) font type change; D) font boldness change; E) font color change; F) font spatial angular rotation change; G) font intermittency/flickering change; H) open proto-bigrams term(s) cells location changes (cell repositioning of open proto-bigrams target(s) terms within their respective assigned visual field regions inside the open proto-bigrams terms matrix); and I) velocity/direction of movement (constant [smooth] displacement) change of all of the target open proto-bigrams terms.

In an embodiment having an arranged open-bigram term matrix of open-bigram terms, the spatial and/or time perceptual related attribute change for the open proto-bigram terms in the arranged open-bigram term matrix may be a font color change and/or a font flickering change. Even more so, the spatial and/or time perceptual related attribute change may be different for each of the left, central, and right group open proto-bigram terms. Specifically, the font color change for left group open proto-bigram terms may be a red font color, the font color change for central group open proto-bigram terms may be a green font color, and the font color change for right group open proto-bigram terms may be a blue font color.

In another non-limiting example, for those open proto-bigram target terms that have cell location changes and a spatial or time perceptual related attribute change, the open proto-bigram target terms may remain in the same cell location within their respective sectors for a third predefined period of time Δ₅, herein defined as 9 seconds. Thereafter, they may then change cell position according to a predefined or randomly selected new cell location within their respective sectors, and remain in the new cell location for the third predefined period of time as before. The open proto-bigram target terms may repeat this changing of cell location in a periodic manner during an exercise. However, open proto-bigram target terms that have been correctly selected by the subject will be excluded from changing cell locations once identified.

For some embodiments of the present example where the spatial or time perceptual related attribute change involves the velocity/direction of movement in the open proto-bigram terms, the horizontal arrays of open-bigram terms for an arranged open-bigram terms matrix may simultaneously move toward a predefined left or right direction in a visual field of the subject at a predefined or randomly selected speed.

In a non-limiting example, for an exercise scenario having two different open proto-bigrams terms, one selected as an open proto-bigram target(s) term and the other selected as the open proto-bigram distractors, both selected different open proto-bigrams terms will be displayed inside the open proto-bigrams terms matrix with same spatial and time perceptual related attributes but NOT with same spatial collective perceptual related attributes. Specifically, the goal of this particular open proto-bigrams terms matrix configuration trial exercise will be to search, recognize, and sensory motor select one or more open proto-bigrams target(s) terms that are specifically visually perceptually different in their respective symbols shape representations given that the selected open proto-bigrams terms occupy different unique serial ordinal positions (each open proto-bigram term serial position in relation to the other) in a particular selected direct or inverse open proto-bigram sequence.

This non-limiting Example 1 includes 5 block exercises. Each block exercise comprises 2 sequential open proto-bigram terms matrices trial exercises wherein the subject is required to visually search, recognize, and sensory motor select the open proto-bigram target terms in a given open proto-bigram terms matrix as quickly as possible. In each trial exercise, an open proto-bigrams term matrix is presented to the subject for a maximal time period T. Let T herein represent the maximal time period a user is given to complete the performance of any open proto-bigrams terms matrix trial exercise of the present task, where maximal time period T is herein defined to be 45 seconds. In a block exercise, once the subject has successfully performed the first open proto-bigrams terms matrix trial exercise, the next in-line open proto-bigrams terms matrix trial exercise will be displayed after a Δ₀ time period, where Δ₀ time period is herein defined to be 7 seconds. In the event the subject has successfully completed performing an open proto-bigrams terms matrix trial exercise before the maximal time period T has expired, performance of the current open proto-bigrams terms matrix trial exercise is promptly ended and the performance of the next in-line open proto-bigrams terms matrix trial exercise within the current block exercise begins after the termination of Δ₀ time period. In all block exercises of the present task, the sequential display of a new open proto-bigrams terms matrix trial exercise #2 begins after the termination of Δ₀ time period. Still, in some embodiments when block exercise #1 ends, every new block exercise thereafter will begin after a Δ₁ time period, where Δ₁ time period is defined to be 17 seconds.

In block exercise 1, the subject is required to visually search, recognize and sensory motor select as quickly as possible the location(s) occupied by one or more open proto-bigram target(s) terms. During trial exercise #1, one or more open proto-bigrams target(s) terms will be displayed at their respective visual field region for the maximal time period T. Specifically, the subject will be required to quickly select (e.g., mouse clicking) on each of the cell location(s) occupied by open proto-bigrams target(s) terms displayed among a crowd of open proto-bigrams distractors terms. The visual search, recognition, and correct sensory motor selection of one or more open proto-bigrams target(s) terms is herein enabled and facilitated because of a single spatial or time perceptual related attribute salient distinction (e.g., font size, font type, font boldness, font angular rotation, etc.) pre-assigned to open proto-bigrams target(s) terms but not to open proto-bigrams distractors terms. The salient spatial or time perceptual related attribute difference stands-out in the subject's visual field view, making the allocation of open proto-bigrams target(s) terms inside the open proto-bigrams terms matrix relatively effortless and fast, even among a crowd of open proto-bigrams distractors terms. Once all of the open proto-bigrams target(s) terms have been successfully sensory motor selected and thereafter Δ₀ time period takes place, trial exercise #2 will begin. FIG. 3A represents a non-limiting example of the exercises for promoting visual search, pattern recognition, and sensory motor selection of open proto-bigrams terms for an arranged open proto-bigrams terms matrix having two different open proto-bigrams terms. In this particular case, one open proto-bigram term (“IF”) is selected as the target term while the other open proto-bigram term (“ME”) is selected as the distractor term. The correctly selected open proto-bigram target term “IF” is shown in FIG. 3B.

FIG. 4A represents another non-limiting example of the exercises for promoting visual search, pattern recognition, and sensory motor selection of open proto-bigram terms. FIG. 4A shows an arranged open proto-bigrams terms matrix having a single open proto-bigram term that represents both the target and distractor terms. However, since only a single open proto-bigram term is utilized, the target and distractor terms are distinguished by spatial perceptual related attribute font size. FIG. 4B shows the correctly selected smaller spatial perceptual related attribute font size open proto-bigram target term “NO.”

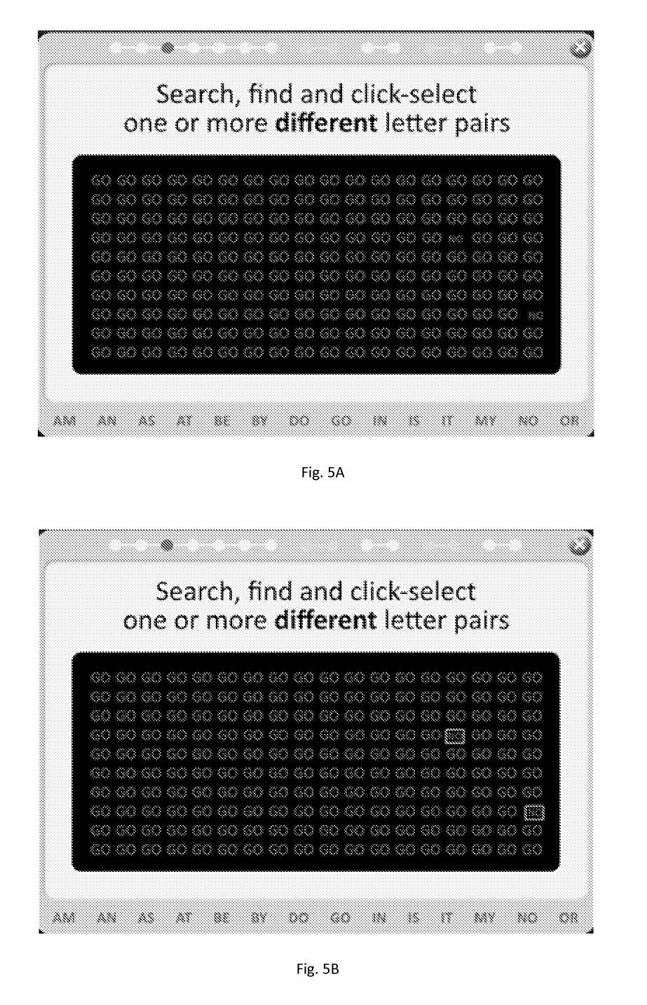

Similarly, FIGS. 5A-5B depict another non-limiting example of the exercises for promoting visual search, pattern recognition, and sensory motor selection of open proto-bigram terms. In this example, FIG. 5A shows an arranged open proto-bigrams terms matrix having two different open proto-bigram terms each represent either the target term or the distractor term. Additionally, the open proto-bigram terms of FIG. 5A are also distinguished from one another by the spatial perceptual related attribute of font size. The correctly identified open proto-bigram target term “NO” is shown in FIG. 5B.

FIGS. 6A-6D show another non-limiting example of the exercises for promoting visual search, pattern recognition, and sensory motor selection of open proto-bigram terms. FIG. 6A shows an arranged open proto-bigrams terms matrix with a single open proto-bigram as the target and distractor terms. Since the target and the distractor terms are a single open proto-bigram, they are distinguished by spatial perceptual related attribute font type. FIG. 6B shows the correctly identified open proto-bigram targets. Similarly, FIGS. 6C and 6D depict another version of an arranged open proto-bigram terms matrix having a single open proto-bigram as the target and distractor terms. In this case, the target and distractor terms are differentiated by spatial perceptual related attribute font boldness. Correctly identified open proto-bigrams target terms are displayed in FIG. 6D.

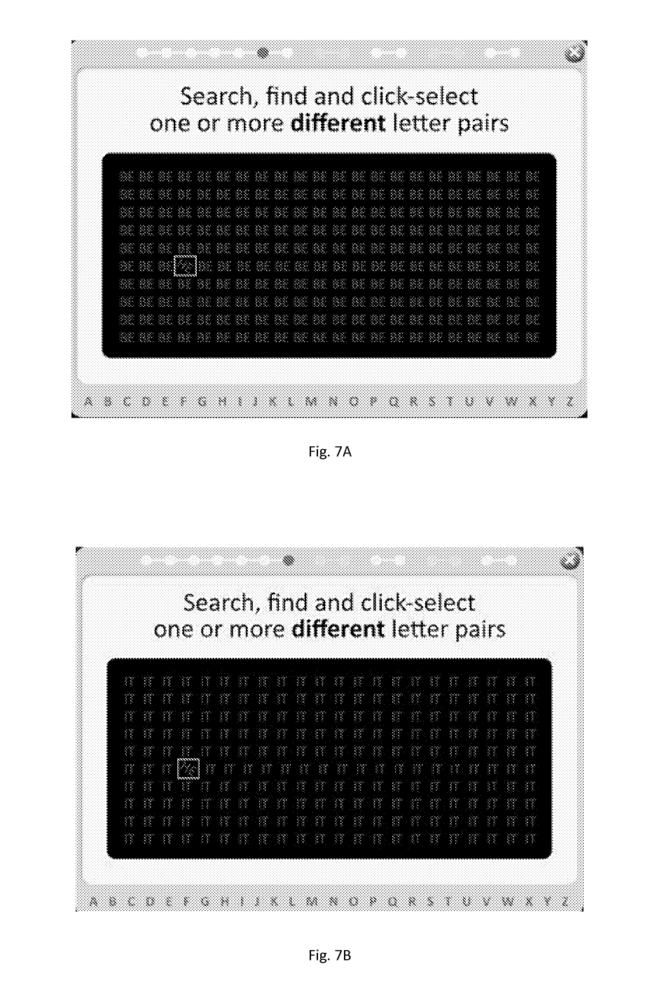

FIG. 7A shows an arranged open proto-bigrams matrix with two different open proto-bigram target and distractor terms, where both of the selected open proto-bigram terms are from the left visual field region (left sector). The open proto-bigram target terms are further distinguished from the open proto-bigram distractors by a different spatial perceptual related attribute font angular rotation. Likewise, FIG. 7B shows another arranged open proto-bigrams terms matrix with two different open proto-bigram target and distractor terms that are also distinguished by the open proto-bigram target term having a different spatial perceptual related attribute font angular rotation. However, in this case, the open proto-bigram target term “HE” is selected from the left visual field region (left sector) while the open proto-bigram distractor term “IT” is selected from the central visual field region (central sector).

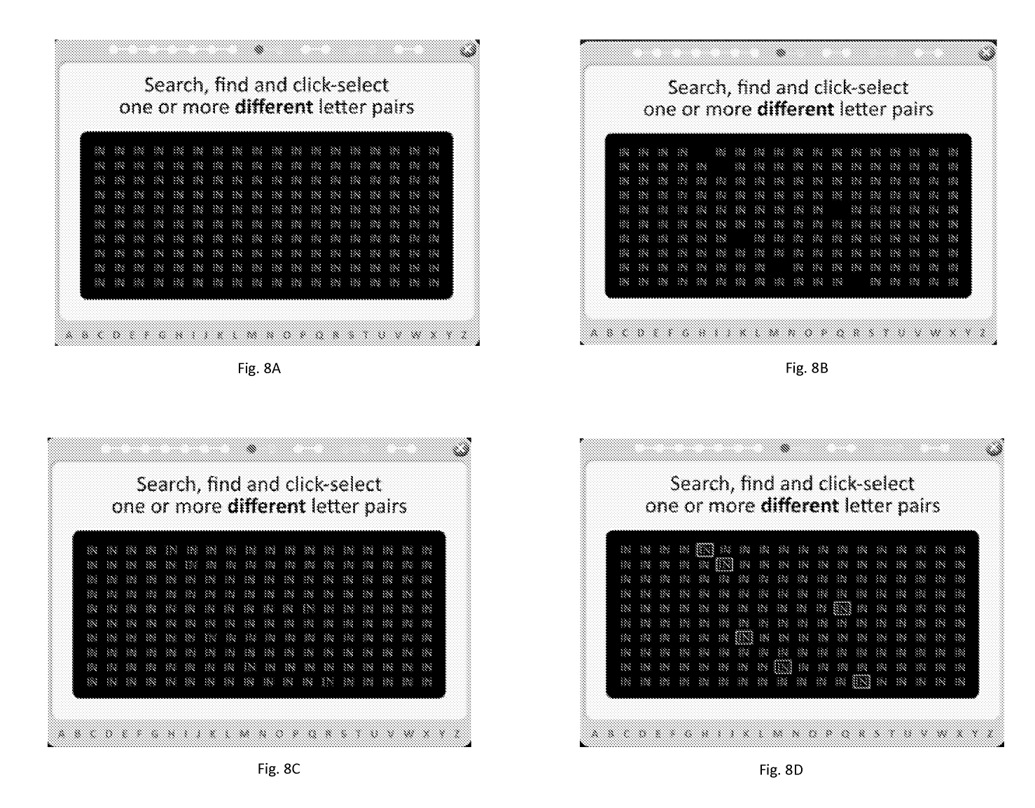

In block exercise #2, the subject is again required to visually search, recognize, and sensory motor select as quickly as possible, the one or more open proto-bigrams target(s) terms inside the open proto-bigrams terms matrix like that shown in FIG. 8A. However, in these set of exercises, a time perceptual related attribute distinction is made on all open proto-bigrams target(s) but not on the distracting crowd of open proto-bigrams distractors terms. The differential implementation of this particular exclusively pre-assigned time perceptual related attribute affecting only open proto-bigrams target(s) terms inside the open proto-bigrams terms matrix, succeeds in generating a degree of visual perceptual ‘difficulty’ and ‘confusion’ in the user, challenging him/her to spot the one or more required open proto-bigrams target(s) terms. Specifically, this differential time perceptual related attribute affecting only open proto-bigrams target(s) terms causes them to disappear intermittently inside the open proto-bigrams terms matrix as shown in FIG. 8B.

In this particular example, when one or more open proto-bigrams target(s) terms are not perceptually visible, they change their open proto-bigram “target” term identity to momentarily become open proto-bigram “distractors” term(s) inside the open proto-bigrams terms matrix as shown in FIG. 8C. In effect, the subject does not see empty target(s) cells but rather an open proto-bigrams terms matrix composed only of open proto-bigrams distractors terms (thus, a perceptual confusion is momentarily in place). To that effect, open proto-bigrams target(s) terms will be displayed intermittently during a time interval Δ₃, where time interval Δ₃ is herein defined to be of 10 seconds. Namely Δ₃ is the time interval where open proto-bigrams target(s) terms are visible inside the open proto-bigrams terms matrix. The number of time intervals Δ₃ allowed to take place in each open proto-bigrams terms matrix trial exercises in block exercise #2 is herein defined to be 3. Additionally, let time interval Δ₄ represent the time interval where all open proto-bigrams target(s) terms suddenly change their open proto-bigram term identity (thus, momentarily not visible) and become open proto-bigrams distractors terms, and where time interval Δ₄ is herein defined to be of 5 seconds. The number of time intervals Δ₄ allowed to take place in each open proto-bigrams terms matrix trial exercises in block exercise #2 is herein defined to be 3. Therefore, it can be easily concluded that the total time available for the subject to correctly sensory motor select all target(s) terms in each open proto-bigrams terms matrix trial exercise in block exercise #2 is of: 3×(Δ₃+Δ₄)=45 secs.

In summary, there is a time interval Δ₃ (10 seconds) during which one or more target(s) open proto-bigrams terms are perceptually visible to the subject's scrutiny and therefore, he/she can visually search, recognize and sensory motor select them. Immediately thereafter there is a time interval Δ₄, (5 seconds) during which the yet non-selected open proto-bigrams target(s) terms suddenly become open proto-bigrams distractors terms and thus the subject is momentarily prevented from visually searching, recognizing and sensory motor selecting any further open proto-bigrams target(s) terms. Once all of the open proto-bigrams target(s) terms have been successfully correctly sensory motor selected, as shown in FIG. 8D, and Δ₀ time period thereafter takes place, a new open proto-bigram terms matrix for trial exercise #2 will begin.

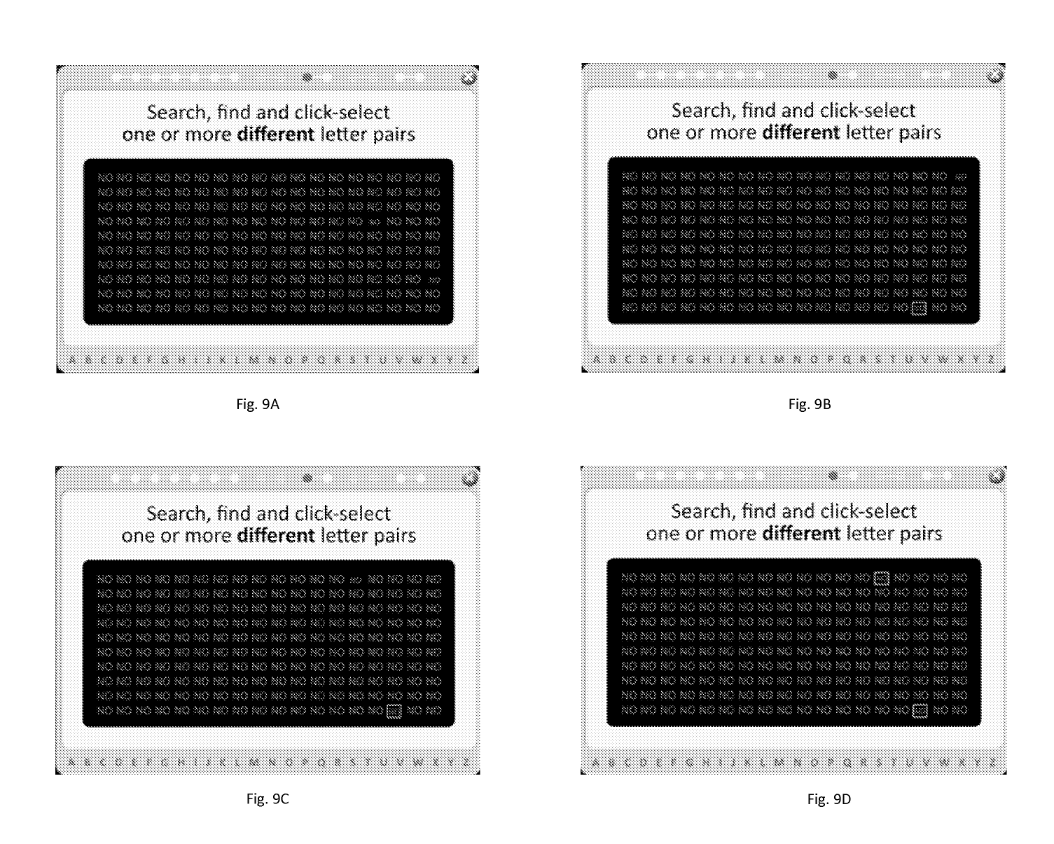

In block exercise #3 the subject is required to visually search, recognize and sensory motor select, as quickly as possible, one or more open proto-bigrams target(s) terms occupying various cell locations in their respective visual field regions inside the open proto-bigrams terms matrix. FIG. 9A shows an initial state of the open proto-bigrams terms matrix with the single open proto-bigram term “NO” representing both the target and distractor terms. A pre-assigned or random cell relocation procedure is applied to all of the open proto-bigrams target(s) terms inside the open proto-bigrams terms matrix, which causes all of the target(s) terms to randomly or in a pre-assigned manner change their cells position within their respective visual field regions, multiple times, during a trial exercise. Specifically, all of the open proto-bigrams target(s) terms will suddenly change their cell(s) locations every time interval Δ₅ herein defined to be 9 seconds. The open proto-bigram target term “NO” is shown as having changed positions in the open proto-bigram terms matrix in FIGS. 9B and 9C. Target terms become exempt from the cell relocation procedure once they are correctly selected by the subject. The number of time intervals Δ₅ allowed to take place in each trial exercise of block exercise #3 is herein defined to be 5.

All of the open proto-bigram target(s) terms will retain their ‘open proto-bigram term identity’ with their pre-assigned spatial or time perceptual related attribute, despite changing cell locations multiple times in their respective visual field regions inside the open proto-bigrams terms matrix during the performance of block exercise #3. Once all of the open proto-bigrams target(s) terms have been successfully sensory motor selected, as shown in FIG. 9D, and Δ₀ time period thereafter takes place, the open proto-bigrams terms matrix trial exercise #2 will begin.

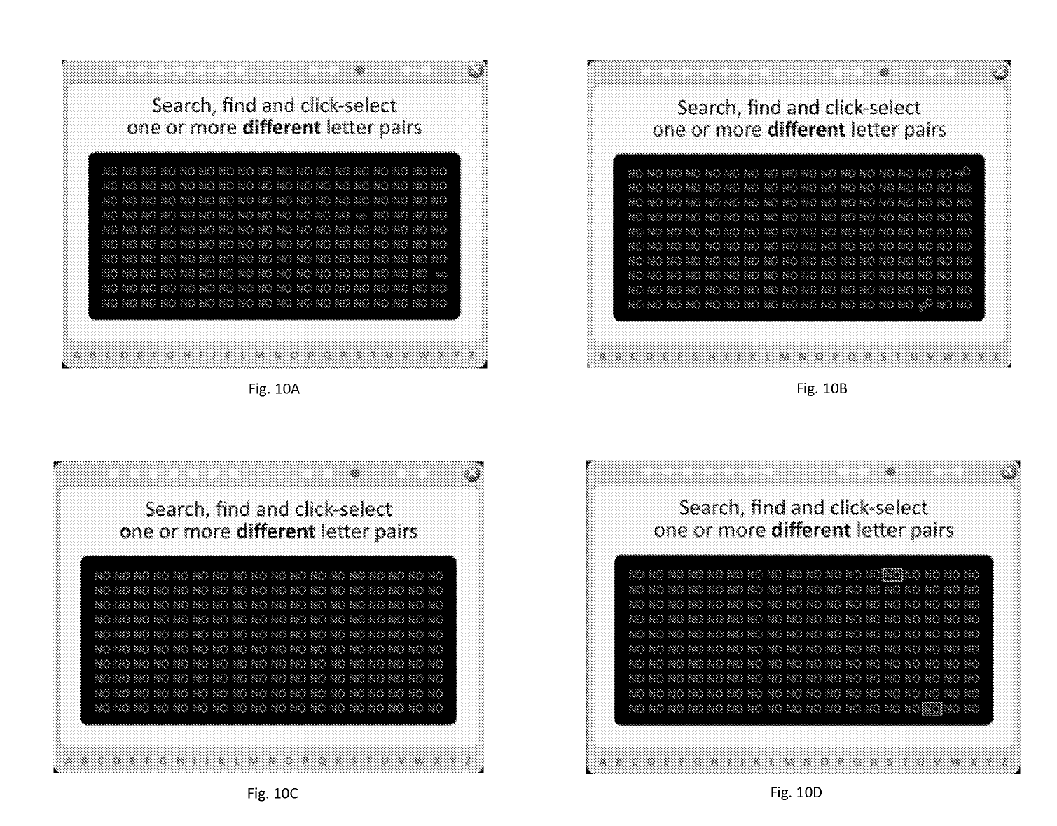

In block exercise #4 the subject is required to visually search, recognize and sensory motor select, as fast as possible, one or more open proto-bigrams target(s) terms occupying various cells positions in their respective visual field region inside the open proto-bigrams terms matrix. FIG. 10A shows an initial state of the open proto-bigram terms matrix with the single open proto-bigram term “NO” representing both the target and distractor terms. A random or pre-assigned cell relocation, as is the case of block exercise #3, is applied to all of the open proto-bigrams target terms as well as a spatial or time perceptual related attribute change to all of the open proto-bigrams target(s) and distractors terms every time the target(s) terms change their cells positions in their respective visual field region of the open proto-bigrams terms matrix. Specifically, every time during an open proto-bigrams terms matrix trial exercise that a random or pre-assigned cell relocation of open proto-bigrams target(s) terms comes to effect, the entire set of open proto-bigrams target(s) and distractors terms is displayed at once with a changed spatial or time perceptual related attribute, as shown in FIG. 10B. It is important to emphasize that the changed spatial or time perceptual related attribute can never be the same for open proto-bigrams target(s) and distractors terms.

All of the open proto-bigrams target(s) terms suddenly change their cell positions either randomly or in a pre-assigned fashion in a time interval Δ₅. Each time that open proto-bigrams target(s) terms change their cells positions all of the open proto-bigram target(s) and distractors terms inside the open proto-bigrams terms matrix are randomly changed to a single new different spatial or time perceptual related attribute (from a library featuring open proto-bigrams terms spatial, spatial collective and time perceptual related attributes), as shown in FIGS. 10C and 10D. The present task implements changes in the distribution of open proto-bigrams target(s) and distractor terms inside the open proto-bigrams terms matrix together with a random change of their spatial or time perceptual related attributes, thereby completely reconfiguring time and time again, the spatial or time perceptual related attribute identity and spatial distribution of all of the open proto-bigrams targets and distractor terms displayed inside the open proto-bigrams terms matrix.

The multiple alteration of open proto-bigrams terms cells positions and spatial or time perceptual related attributes, triggers a strong attentional orienting effect in the user (e.g., the next in-line open proto-bigrams terms configuration that the user is expecting to see gets confirmed or violated) that may efficiently succeed in rapidly steering his/her focus of visual attention, expediting the search, recognition and sensory motor selection of one or more open proto-bigrams target(s) terms in the next in-line open proto-bigrams target(s) and distractor terms configuration. This way open proto-bigrams term configurations are extended in time and therefore, are correlated with each other. Still, this temporal correlation among multiple open proto-bigrams targets and distractors configurations prompts a subject's peripheral attentional deployment to asymmetrically facilitate the parallel search, recognition and sensory motor selection of open proto-bigram target(s) terms while at the same time visually perceptually attentionally ignoring/downplaying the open proto-bigram distractor terms. Once all of the open proto-bigrams target(s) terms have been successfully correctly sensory motor selected, as shown in FIG. 10D, and Δ₀ time period takes place, open proto-bigrams terms matrix trial exercise #2 begins.

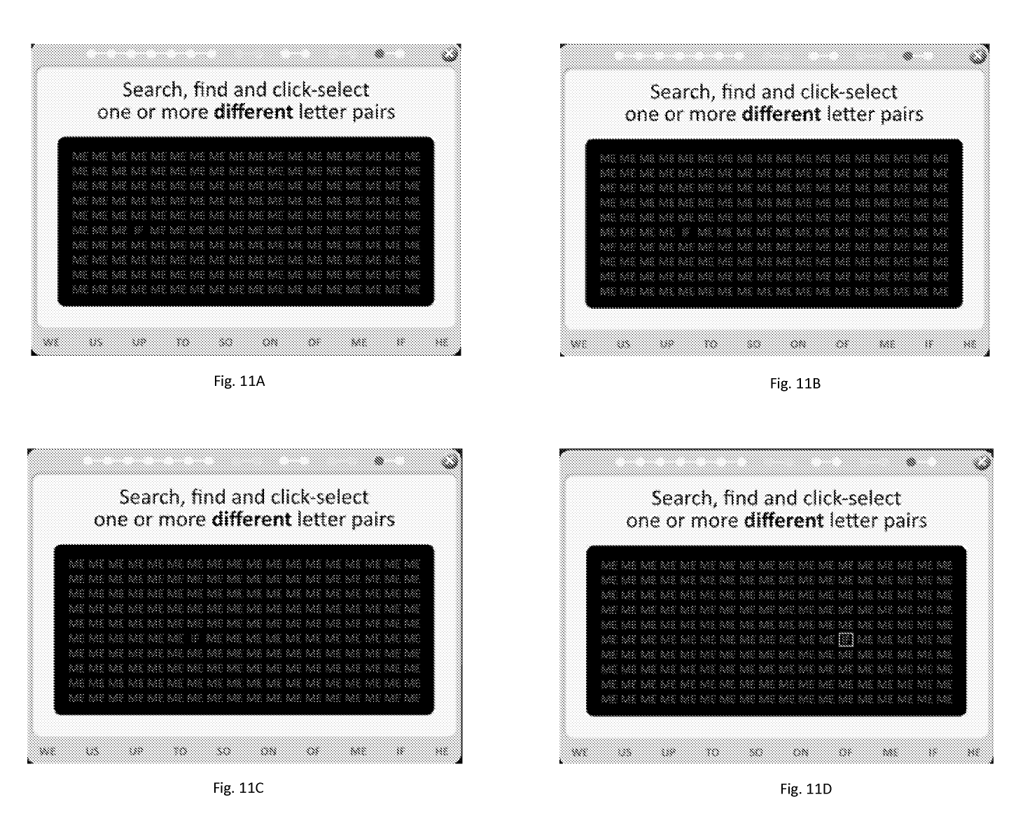

In block exercise #5 the subject is required to visually search, recognize and sensory motor select, as quickly as possible, one or more open proto-bigrams target(s) terms in their respective visual field regions inside the open proto-bigrams terms matrix. FIG. 11A depicts an arranged open proto-bigrams terms matrix containing two different open proto-bigram target and distractor terms both selected from the same visual field region. A time perceptual related attribute change for all of the open proto-bigrams target(s) and distractors terms is applied causing them to linearly displace inside of the open proto-bigrams terms matrix, which gives the subject the visual perception of an “open proto-bigram terms motion flow.” Specifically, this particular time perceptual related attribute change simultaneously shared by all of the open proto-bigrams targets and distractor terms displayed in the open proto-bigrams terms matrix, generates in the user, a visual effect manifesting in a perceptual 2D laminar motion constant flow-like displacement of all of the open proto-bigrams targets and distractor terms inside the open proto-bigrams terms matrix. Accordingly, this motion flow displacement takes place from the left-inside boundary of the open proto-bigrams terms matrix towards the right-inside boundary of the open proto-bigrams terms matrix, but it may also occur in the opposite direction.

All of the open proto-bigram terms in the open proto-bigrams terms matrix move (e.g., displace from left to right) simultaneously with a time perceptual related attribute velocity, such that all of the displayed open proto-bigrams terms visually-perceptually smoothly disappear from view from the far right-inside edge-boundary of the open proto-bigrams terms matrix and re-emerge continuously from the left-inside edge-boundary of the open proto-bigrams terms matrix, and as shown in FIGS. 11B and 11C. Let time perceptual related attribute V herein represent velocity (V representing the temporal rate of spatial displacement), where time perceptual related attribute velocity V values are randomly obtained from a library featuring open proto-bigrams terms spatial, spatial collective and time perceptual related attributes.

In block exercise #5, all performance requirements remain identical to those in block exercise #1 above, with the exception of the newly introduced time perceptual related attribute velocity V, causing all of the open proto-bigrams terms inside the open proto-bigrams terms matrix to linearly smoothly move towards one of the boundaries of the open proto-bigrams terms matrix. Once the user has successfully correctly completed the sensory motor selection of all of the open proto-bigrams target(s) terms inside the open proto-bigrams terms matrix in open proto-bigrams terms matrix trial exercise #2 as shown in FIG. 11D, the present task ends and the subject is promptly directed back to the main menu.

As a non-limiting example, in all of the block exercises, the subject is provided with a graphical representation of a complete open proto-bigrams terms sequence in a ruler displayed underneath the open proto-bigrams terms matrix display surface. The visual presence of the ruler facilitates the subject's ability to rapidly visually search and recognize the location of one or more open proto-bigrams target(s) terms inside the open proto-bigrams terms matrix. Particularly, the subject sensory motor selects one open proto-bigram target term at a time, within the crowd of open proto-bigrams distractors terms inside the open proto-bigrams terms matrix. Once the subject has successfully correctly completed to sensory motor select all the of the open proto-bigrams target(s) terms in any trial exercise, the particular sensory motor selected open proto-bigram target(s) terms will immediately become highlighted with time perceptual related attribute color or flicker with time perceptual related attribute flickering frequency in the ruler as well as in its respective open proto-bigrams terms matrix cells and will remain highlighted or in flickering mode for a time interval t₂, where time interval t₂ is herein defined to be of 12 seconds. Within the same block exercise, after Δ₀ time period has expired, the next in-line open proto-bigrams terms matrix trial exercise will be displayed and after Δ₁ time period has expired, the next in-line open proto-bigrams terms matrix trial exercise in a new block exercise will be displayed.

The ruler display effortlessly accelerates visual spatial search (spotting) and recognition of the embedded open proto-bigrams target(s) terms within the crowd of open proto-bigrams distractor terms. In the present exercises, the ruler contains an alphabetic letters sequence selected from a plurality of alphabetic letters sequences including: direct open proto-bigram sequence, inverse open proto-bigram sequence, complete open proto-bigram sequence, direct open-bigram set array, inverse open-bigram set array, direct type open-bigram set array, inverse type open-bigram set array, central type open-bigram set array, and inverse central type open-bigram set array. The methods implemented by the exercises of Example 1 also contemplate those situations in which the subject fails to perform the given task. The following failing to perform criteria is applicable to any exercise in any block exercise of the present task in which the subject fails to perform. Specifically, for the present exercises, there are two kinds of “failure to perform” criteria. The first kind of “failure to perform” criteria occurs in the event the subject fails to perform by not click-selecting (the subject remains inactive/passive) with the hand-held mouse device on any open proto-bigram target term from the open proto-bigram terms matrix within a valid performance time period, such as 15 seconds; a new open proto-bigrams terms trial exercise is then executed immediately thereafter.

The second “failure to perform” criteria is in the event the subject fails to perform by incorrectly selecting a number of open proto-bigram target terms from the open proto-bigram terms matrix Additionally and irrespective of the valid performance time period, when the subject selects three (3) incorrect open proto-bigram term answers for a given open proto-bigram terms matrix, the current trial exercise performance in the current block exercise is terminated and the next in line block exercise will be displayed.

The total duration to complete the exercises of Example 1, as well as the time it took to implement each one of the individual open proto-bigrams terms trial exercises, is registered in order to help generate an individual and age-gender group performance score. Incorrect sensory motor selections of open proto-bigram target terms and open proto-bigram target terms serial pattern sensory motor selection are also recorded and counted as part of the subject's performance score. In general, the subject will perform the exercises of Example 1 about 6 times during his/her language based brain neuroperformance-fitness training program.

1. A method to promote searching, pattern recognition, and sensory motor selection of open-bigram terms in a subject comprising:
a) selecting a first open-bigram term with a semantic meaning and a second open-bigram term from a library of open-bigram terms, the first and second open-bigram terms having the same spatial and time perceptual related attributes; arranging a predefined number of the second open-bigram term in a number of arrays forming a predefined matrix format; replacing an equal number of the second open-bigram term with a predefined number of the first open-bigram term in one or more sectors of the matrix, the first open-bigram term representing a target term and the second open-bigram term representing a distractor term; and providing the subject with the matrix and a ruler displaying a predefined alphabetic open-bigram sequence selected from direct open proto-bigram sequence, inverse open proto-bigram sequence, complete open proto-bigram sequence, direct open-bigram set array, inverse open-bigram set array, direct type open-bigram set array, inverse type open-bigram set array, central type open-bigram set array, and inverse central type open-bigram set array;
b) prompting the subject to search, recognize, and sensory motor select all instances of the target term in the arranged matrix within a first predefined period of time;
c) if the sensory motor selection is incorrect, then returning to step b);
d) if the sensory motor selection is correct, then changing at least one spatial and/or time perceptual related attribute of the selected target term in the matrix and the ruler;
e) if all instances of the target term are correctly selected according to step b), then after the last target term is selected from the matrix, immediately changing at least one spatial and/or time perceptual related attribute of all of the correctly selected target terms in the matrix and the ruler again;
f) repeating the above steps for a predefined number of iterations, each iteration separated by a second predefined period of time; and
g) presenting the subject with results from each iteration at the end of the predefined number of iterations.

2. The method of claim 1, wherein the library of open-bigram terms is obtained from the English language.

3. The method of claim 1, wherein the first open-bigram term is an open proto-bigram term and the second open-bigram term is selected from alphabetic open-bigram set arrays and any open-bigram term of non-repeated letters that is neither an open proto-bigram term nor an alphabetic open-bigram set array.

4. The method of claim 3, wherein the alphabetic open-bigram set arrays comprise: direct open-bigram set arrays, inverse open-bigram set arrays, direct type open-bigram set arrays, inverse type open-bigram set arrays, central type open-bigram set arrays, and inverse central type open-bigram set arrays.

5. The method of claim 1, wherein the arranging of the predefined number of the second open-bigram term follows a previously selected direct or inverse alphabetic serial order.

6. The method of claim 1, wherein the arranging of the predefined number of the second open-bigram term is done at random.

7. The method of claim 1, wherein a total number of distractor and target terms in each array is between 12 and 24.

8. The method of claim 1, wherein the predefined matrix format is obtained by a selected number of horizontal arrays arranged together.

9. The method of claim 8, wherein the selected number of horizontal arrays is between 30 and 50.

10. The method of claim 1, wherein left and right border limits of the predefined matrix format do not line up to form a straight vertical line in accordance with a predefined number of horizontal arrays with different numbers of open-bigram terms.

11. The method of claim 1, wherein the predefined matrix format has a left sector having the closest integer number to 20% of all of the open-bigram terms, a central sector having the closest integer number to 50% of all of the open-bigram terms, and a right sector having the closest integer number to 30% of all of the open-bigram terms, or any other proportion of open-bigram terms wherein the left sector has 30% or less of all the open-bigram terms and right sector has at least 20% of all of the open-bigram terms.

12. The method of claim 1, wherein the target and distractor terms are open proto-bigrams.

13. The method of claim 1, wherein a predefined number of the second open-bigram term become target terms in the matrix.

14. The method of claim 3, wherein the open proto-bigram term is selected from one or more of the following groups including:
Direct Open Proto-Bigram Sequence;
Inverse Open Proto-Bigram Sequence;
Complete Open Proto-Bigram Sequence;
Left Group: AM, BE, HE, IF, ME;
Central Group: AN, AS, AT, BY, DO, GO, IN, IS, IT, MY, OF, WE; and
Right Group: NO, ON, OR, SO, TO, UP, US.

15. The method of claim 14, wherein open proto-bigram target terms selected from the left group are only present in a left sector of the predefined matrix, open proto-bigram target terms selected from the central group are only present in a central sector of the predefined matrix, and open proto-bigram target terms selected from the right group are only present in a right sector of the predefined matrix, and wherein open proto-bigram terms are displayed in the ruler.

16. The method of claim 15, wherein if the open proto-bigram target terms are from the left group, no open proto-bigram distractor terms from the right group will be present in the predefined matrix; if the open proto-bigram target terms are from the right group, no open proto-bigram distractor terms from the left group will be present in the predefined matrix; and if the open proto-bigram target terms are from the central group, only distractor terms selected from the central group will be present in the predefined matrix.

17. The method of claim 1, wherein the changed at least one spatial and/or time perceptual related attribute of the target terms in step d) is a font color change and/or a font flickering change.

18. The method of claim 14, wherein the changed at least one spatial and/or time perceptual related attribute of the target terms in step d) is a font color change that is a red font color for the left group of open proto-bigram terms, a green font color for the central group of open proto-bigram terms, and a blue font color for the right group of open proto-bigram terms.

19. The method of claim 1, wherein the number of target terms ranges from 1 to 9, and a combined total number of distractor and target terms ranges from 360 to 1200.

20. The method of claim 15, wherein only one target term is allowed to be present in the left sector, up to two target terms are allowed to be present in the right sector, and three to six target terms are allowed to be present in the central sector.

21. The method of claim 1, wherein prior to step b) the distractor and target terms are perceptually differentiated from each other by preselected different spatial and/or time perceptual related attributes.

22. The method of claim 15, wherein the target terms remain in the same location within their respective sectors inside the predefined matrix for a third predefined period of time, then change position according to a predefined or randomly selected new location within their respective sectors, and remain in the new location for the third predefined period of time, repeating the change of position periodically, and where target terms already selected in step b) are excluded from the target terms that continue to change location.

23. The method of claim 22, wherein the third predefined period of time ranges from 4 to 9 seconds.

24. The method of claim 8, wherein the subject executes step b) while the horizontal arrays are simultaneously moving towards a predefined right or left direction in a visual field of the subject at a speed value that is previously defined or selected at random from a library of predefined speed values for the horizontal arrays in the predefined matrix.

25. The method of claim 1, wherein the predetermined iterations ranges from 1 to 7 iterations.

26. The method of claim 1, wherein the first predefined period of time is 45 seconds and the second predefined period of time is 7 seconds.

27. The method of claim 1, wherein the sensory motor selection includes one or more sensory motor activities selected from the group consisting of: touching a screen where the selected target term is located, clicking on the selected target term with a mouse, voicing sounds the selected target term represents, and touching each selected target term from the matrix with a pointer or stick.

28. The method of claim 15, wherein the target terms are selected to periodically vanish from the predefined matrix or to change location within one of the left, central, or right sectors, according to predefined timings, until recognized and selected according to step b).

29. A computer program product for promoting searching, pattern recognition, and sensory motor selection of open-bigram terms in a subject, stored on a non-transitory computer-readable medium which when executed causes a computer system to perform a method, comprising:
a) selecting a first open-bigram term with a semantic meaning and a second open-bigram term from a library of open-bigram terms, the first and second open-bigram terms having the same spatial and time perceptual related attributes; arranging a predefined number of the second open-bigram term in a number of arrays forming a predefined matrix format; replacing an equal number of the second open-bigram term with a predefined number of the first open-bigram term in one or more sectors of the matrix, the first open-bigram term representing a target term and the second open-bigram term representing a distractor term; and providing the subject with the matrix and a ruler displaying a predefined alphabetic open-bigram sequence selected from direct open proto-bigram sequence, inverse open proto-bigram sequence, complete open proto-bigram sequence, direct open-bigram set array, inverse open-bigram set array, direct type open-bigram set array, inverse type open-bigram set array, central type open-bigram set array, and inverse central type open-bigram set array;
b) prompting the subject to search, recognize, and sensory motor select all instances of the target term in the matrix within a first predefined period of time;
c) if the sensory motor selection made by the subject is an incorrect selection, then returning to step b);
d) if the sensory motor selection made by the subject is a correct selection, then changing at least one spatial and/or time perceptual related attribute of the selected target term in the matrix and the ruler;
e) if all instances of the target term are correctly selected according to step b), then after the last target term is selected from the matrix, immediately changing at least one spatial and/or time perceptual related attribute of all of the correctly selected target terms in the matrix and the ruler again;
f) repeating the above steps for a predefined number of iterations, each iteration separated by a second predefined period of time; and
g) presenting the subject with results from each iteration at the end of the predefined number of iterations.

30. A system for promoting searching, pattern recognition, and sensory motor selection of open-bigram terms in a subject, the system comprising:
a computer system comprising a processor, memory, and a graphical user interface (GUI), the processor containing instructions for:
a) selecting a first open-bigram term with a semantic meaning and a second open-bigram term from a library of open-bigram terms; arranging a predefined number of the second open-bigram term in a number of arrays forming a predefined matrix, replacing an equal number of the second open-bigram term with a predefined number of the first open-bigram term in one or more sectors of the matrix, wherein the first and second open-bigram terms have the same spatial and time perceptual related attributes and the first open-bigram term represents a target term and the second open-bigram term represents a distractor term; and providing the matrix and a ruler, displaying a predefined alphabetic open-bigram sequence selected from direct open proto-bigram sequence, inverse open proto-bigram sequence, complete open proto-bigram sequence, direct open-bigram set array, inverse open-bigram set array, direct type open-bigram set array, inverse type open-bigram set array, central type open-bigram set array, and inverse central type open-bigram set array, to the subject on the GUI;
b) prompting the subject on the GUI to search, recognize, and sensory motor select all instances of the target term in the matrix within a first predefined period of time; and determining if the subject correctly selected a target term;
c) if the sensory motor selection made by the subject is incorrect, then returning to the step of prompting the subject to search, recognize, and select all of the target terms in the matrix;
d) if the sensory motor selection made by the subject is a correct selection, then displaying the correctly selected target term on the GUI with a changed spatial and/or time perceptual related attribute in the matrix and the ruler;
e) if the selection made by the subject is the last correct target term from the matrix, then immediately displaying all of the correctly selected target terms on the GUI again with another changed spatial and/or time perceptual related attribute in the matrix and the ruler;
f) repeating the above steps for a predefined number of iterations, each iteration separated by a second predefined period of time; and
g) upon completion of a predefined number of iterations, providing the subject with the results of all of the iterations.
